(19) United States
(12) Patent Application Publication
(10) Pub. No.: US 2006/0057467 A1
(43) Pub. Date: Mar. 16, 2006

(54) Hologram recording material and hologram recording method

(75) Inventor: Hiroo Takizawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/223,200

(22) Filed: Sep. 12, 2005

(30) Foreign Application Priority Data
Sep. 16, 2004 (JP) P. 2004-269796

(51) Int. Cl. G03H 1/04

(52) U.S. Cl. 430/1; 430/2; 430/20; 359/3

(57) ABSTRACT

A hologram recording material and a hologram recording method, capable of attaining a high sensitivity, a high diffraction efficiency, a satisfactory storability and a dry processability at the same time and applicable to a high-density optical recording medium, a three-dimensional display, a holographic optical element and the like, are provided. The hologram recording method is characterized in causing a change in an alignment of a compound having a specific birefringence upon holographic exposure and fixing the alignment by a chemical reaction so as to record an unrewritable modulation in refractive index in a unrewritable mode. The hologram recording material is characterized in including a low-molecular liquid crystalline compound having a polymerizable group, a photoreactive compound, and a polymerization initiator, and being of an unrewritable type.

### FIELD OF THE INVENTION

The present invention relates to a hologram recording material and a hologram recording method applicable to a high-density optical recording medium, a three-dimensional display, and a holographic optical element and the like.

### BACKGROUND OF THE INVENTION

A general principle of hologram preparation are described in certain literatures and publishings, such as Junpei Tsujiuchi, “Holographic Display”, published by Sangyo Tosho. In such principle, one of two coherent laser beams irradiates an object to be recorded, and a hologram recording material is placed in a position capable of receiving a total reflected light therefrom. The hologram recording material is irradiated, in addition to the reflected light from the object, directly by the other coherent light beam which arrives without going through the object. The reflected light from the object is called an object light, while the light directly irradiating the recording material is called a reference light, and interference fringes of the reference light and the object light are recorded as image information. Then, when a light (reproducing illumination light) same as the reference light irradiates the processed recording material, it is so diffracted by the hologram as to reproduce a wave front of the reflected light when it at first reaches the recording material from the object at the recording, whereby an object image, substantially same as the real image of the object, can be viewed three-dimensionally.

A hologram prepared by introducing the reference light and the object light from a same direction into the hologram recording material is called a transmission hologram. The interference fringes are formed perpendicularly or almost perpendicularly to the film surface of the recording material, with a pitch of 1000-3000 fringes per millimeter.

On the other hand, a hologram prepared by introducing the reference light and the object light from mutually opposite sides of the hologram recording material is called a reflective hologram. The interference fringes are formed parallel or almost parallel to the film surface of the recording material, with a pitch of 3000-7000 fringes per millimeter.

The transmission hologram can be prepared by a known method described for example in JP-A-6-43634. Also the reflective hologram can be prepared by a known method described for example in JP-A-2-3082 and JP-A-3-50588.

Also, a hologram having a film thickness sufficiently larger than the pitch of the interference fringes (usually a film thickness of about 5 times or more of the pitch of the interference fringes or of about 1 μm or larger) is called a volume hologram.

On the other hand, a hologram having a film thickness of 5 times or less of the pitch of the interference fringes or of about 1 μm or less is called a planar or surface hologram.

Also a hologram which records interference fringes by an absorption of a dye or silver is called an amplitude hologram, and a hologram which performs a recording by a surface relief formation or a refractive index modulation is called a phase hologram. The amplitude hologram is unfavorable in the efficiency of light utilization because the light absorption significantly decreases a diffraction efficiency or a reflection efficiency of light, and a phase hologram is advantageously employed.

The hologram can reproduce a three-dimensional stereo image, and, because of its excellent design property and decorating property, is utilized in a front cover of books and magazines, a display such as POP and a gift item. It is also employed in credit cards, banknotes, packages and the like for the purpose of antiforging, thus constituting a large market.

Such hologram is a surface relief phase hologram of planar type. It is usually mass produced from an embossed master prepared with a photoresist, and is therefore called an embossed hologram

However such surface relief phase hologram is difficult to achieve a full-color image, a reproduction with white light, a high resolution and a high diffraction efficiency, and a volume phase hologram capable of achieving these properties is recently attracting attention.

A volume phase hologram can modulate a phase of a light without a light absorption, by forming a plurality of interference fringes different in the refractive index, instead of the optical absorption, in the hologram recording material.

In particular, the volume phase hologram of reflective type is also called Lippman hologram, and is capable, by a wavelength-selective reflection by Bragg's diffraction, of achieving a full-color image, a reproduction with white light and a high resolution, whereby a high-resolution full-color three-dimensional display can be realized.

Also utilizing the wavelength-selective reflection, it is widely applied to holographic optical elements (HOE) such as a head-up display (HUD) for an automobile, a pickup lens for an optical disk, a head-mount display, a color filter for a liquid crystal display, a reflecting plate for a reflective liquid crystal display.

In addition, it is commercially practiced or investigated in a lens, a diffraction grating, an interference filter, a coupler for an optical fiber, a photodeflector for a facsimile, a window pane material for a building and the like.

The known recording material for the volume phase hologram includes, as a write-once type, a bichromate-gelatin system, a bleached silver halide system and a photopolymer system, and, as a rewritable type, a photorefractive system and a photochromic polymer system.

However, among such known recording materials for the volume phase hologram, no material is not yet known to satisfy all the requirements, particularly in the application for a high-sensitivity high-resolution full-color three-dimensional display, and improvements are being desired.

More specifically, the bichromate-gelatin system has advantages of a high diffraction efficiency and low noise characteristics, but is associated with drawbacks of a very poor storability, a necessity of a wet processing and a low sensitivity.

Also the bleached silver halide system has an advantage of a high sensitivity, but is associated with drawbacks of requiring a wet process involving a cumbersome bleaching process, and a poor light fastness.

The photorefractive system has an advantage of being rewritable, but is associated with drawbacks of requiring a high electric field at the recording, and a poor storability of recording.

The photochromic polymer system, represented for example by an azobenzene polymer material, also has an advantage of being rewritable, but is associated with drawbacks of an extremely low sensitivity and a poor storability of record.

Among these, a dry process photopolymer system disclosed in JP-A-6-43634, JP-A-2-3082 and JP-A-3-50588 employs a basic composition of a binder, a radical polymerizable monomer and a photopolymerization initiator and creates a difference in the refractive index by employing a compound having an aromatic ring, chlorine or bromine in either of the binder and the radical polymerizable monomer in order to increase the refractive index modulation, whereby the polymerization proceeds with a concentration of the monomer in light parts of the interference fringes and a concentration of the binder in dark parts of the interference fringes, formed at the holographic exposure, thereby generating a difference in the refractive index. Therefore, it can be considered as a relatively practical system in which a high diffraction efficiency and a dry process can be realized at the same time.

However, such system involves drawbacks of a poor sensitivity of about 1/1000 in comparison with the bleached silver halide system, a necessity for a heat fixing treatment as long as almost 2 hours for improving the diffraction efficiency, an inhibition by oxygen of the involved radical polymerization, and a shrinkage of the recording material after exposure and fixation thereby resulting in a change in diffraction wavelength and angle at the reproducing operation, and further improvements are being desired.

On the other hand, the recent progress of so-called information society rapidly promotes pervasiveness of networks such as Internet and the high-vision TV. Also the broadcasting of the HDTV (high definition television) is planned shortly, and there is anticipated an increasing demand, also in consumer applications, for a high-density recording medium capable of recording image information of 100 GB or more inexpensively and easily.

Also the progress of the computers toward a higher capacity is promoting, also in business applications such as computer backup or broadcasting backup, a demand for an ultra high-density recording medium capable of inexpensively recording information of a large capacity of 1 TB or more, at a high speed.

In such trends, a compact and inexpensive optical recording medium, being flexible and capable of random access, is considered promising in comparison with a magnetic tape incapable of random access or a hard disk which is not exchangeable and often causes failures. However, in an existing two-dimensional optical recording medium such as DVD-R, a storage capacity is limited to about 25 GB at maximum because of the physical principle even if a short wavelength is employed for recording and reproduction, and a sufficiently large recording capacity capable of meeting the future demand cannot be anticipated.

Therefore, as an ultimate high-density recording medium, a three-dimensional optical recording medium which performs recording in the direction of thickness is recently attracting attention. Promising candidates for such purpose include a method utilizing a two-photon absorbing material and a method utilizing holography (interference), and the volume phase hologram recording material is being investigated actively as a three-dimensional optical recording medium.

An optical recording medium utilizing a volume phase hologram recording material records a plurality of two-dimensional digital information (also called signal light) utilizing a spatial light modulator (SLM) such as DMI or LCD, instead of an object light reflected from a three-dimensional object. At the recording, there are performed multiplex recording such as an angular multiplexing, a phase multiplexing, a wavelength multiplexing or a shift multiplexing, thereby realizing a capacity as high as 1 TB. Also a readout operation is performed with a CCD or a CMOS sensor, and a transfer rate as high as 1 Gbps can be realized by parallel writing and readout.

However, requirements for the hologram recording material for such holographic memory are even stricter than those for application for a three-dimensional display or an HOE, as indicated in the following:

(1) a high sensitivity;

(2) a high resolution;

(3) a high diffraction efficiency of hologram;

(4) a dry and rapid processing at the recording;

(5) an ability for multiplex recording (a wide dynamic range);

(6) a low shrinkage after recording; and

(7) a satisfactory storability of hologram.

In particular, the requirement of (1) high sensitivity is chemically contradictory to those of (3) high diffraction efficiency, (4) dry process, (6) low shrinkage after recording and (7) satisfactory storability, and it is difficult to satisfy these requirements at the same time.

For example, the bleached silver halide system has a high sensitivity, but is generally unsuitable for a high-density recording material as it required a wet process.

Also the dry photopolymer system utilizing a radical polymerization as described in JP-A-6-43634, JP-A-2-3082 and JP-A-3-50588 has a relatively high sensitivity among the photopolymer systems, but shows an extremely large shrinkage that is totally unsuitable for a holographic memory. Also it involves a soft film which is insufficient in storability.

In general, in comparison with a radical polymerization, a cationic polymerization, particularly a ring-opening cationic polymerization of an epoxy compound or the like, shows a smaller shrinkage after polymerization, also is not subjected to an inhibition of polymerization by oxygen, and provides a film with a rigidity. It is therefore pointed out that a cationic polymerization is more suitable for the application as a holographic memory.—

For example, JP-A-5-107999 and JP-A-8-16078 disclose a hologram recording material employing a cationic polymerizable compound (monomer or oligomer) instead of a binder, and further combining a sensitizing dye, a radical polymerization initiator, a cationic polymerization initiator and a radical polymerizable compound.

Also JP-T-2001-523842 and JP-T-11-512847 disclose a hologram recording material not utilizing a radical polymerization but employing a sensitizing dye, a cationic polymerization initiator, a cationic polymerizable compound and a binder only.

However, these cationic polymerization systems, though showing an improvement in the shrinkage rate in comparison with the radical polymerization system, show a decreased sensitivity as a trade-off, which will lead to a major drawback in the transfer rate in the practice. These system also show a lowered diffraction efficiency, which will lead to drawbacks in an S/N ratio and a multiplex recordability.

As the photopolymer system involves a material transfer, in the application to a holographic memory, there results a dilemma as explained in the foregoing that an improved storability and a reduced shrinkage lead to a decreased sensitivity (cationic polymerization system) and an improved sensitivity leads to a loss in the storability and the shrinkage (radical polymerization system). Also in order to increase the recording density of a holographic memory, there is required recordings of 50 times or more and preferably 100 times or more (multiplex recording), and, in the photopolymer system utilizing a polymerization process involving a material transfer for recording, the recording speed becomes lower in a latter stage of the multiplex recording where a large proportion of the compound has already polymerized in comparison with an initial stage of the multiplex recording, and it is practically difficult to regulate the exposure amount and to obtain a wide dynamic range by controlling such difference in the recording speed.

On the other hand, WO No. 9744365A1 discloses a rewritable hologram recording material utilizing an anisotropy in refractive index and an alignment control in an azobenzene polymer (photochromic polymer), but such material is far from practical use because of an extremely low sensitivity as it has a low quantum yield in the isomerization of azobenzene and involves an alignment control, and also of a poor storability of record as a trade-off of rewritability. Also the rewritability is often undesirable because the record may be erroneously erased. Also JP-A-5-80309 discloses a method of sandwiching a composition constituted of a binder polymer, a polymerizable liquid crystal monomer having a refractive index anisotropy and a photopolymerization initiator between transparent conductive films, and applying an electric field to the partially cured composition thereby reversibly controlling presence/absence of reflection, but such method involves drawbacks of a necessity of electric field application and a poor record storability and is unapplicable, because of its principle, to an optical recording medium or a display hologram (3D imaging), requiring recording of arbitrary information in an arbitrary location.

The aforementioned trade-off between a high sensitivity and a satisfactory storability and a low shrinkage, and the limitation in the multiplex recordability are difficult to avoid, because of the physical laws, within the photopolymer system involving the material transfer. Also the known systems utilizing the alignment control of the liquid crystalline compound cannot meet the requirements of the optical recording medium in the sensitivity and the storability.

Therefore, in order to apply a hologram recording material to a holographic memory, there is strongly desired the development of a totally novel recording method capable of fundamentally resolving such drawbacks, particularly attaining a high sensitivity, a low shrinkage, a satisfactory storability, a dry processability and a multiplex recordability at the same time.

### SUMMARY OF THE INVENTION

An object of an illustrative, non-limiting embodiment of the present invention is to provide a hologram recording material and a hologram recording method capable of attaining a high sensitivity, a high diffraction efficiency, a satisfactory storability and a dry processability at the same time and applicable to a high-density optical recording medium, a three-dimensional display, a holographic optical element and the like.

As a result of intensive investigations by the present inventors, the aforementioned object of the invention is attained by following means.

(1) A hologram recording method characterized in causing a change in an alignment of a compound having a specific birefringence upon holographic exposure, and fixing the alignment of the compound by a chemical reaction to form a unrewritable modulation in refractive index.

(2) A hologram recording method described in (1), characterized in that the compound having the specific birefringence has a polymerizable group, and the fixing is performed by polymerizing the compound.

(3) A hologram recording method described in (1) or (2), characterized in that the compound having the specific birefringence is a liquid crystalline compound.

(4) A hologram recording material characterized in including at least a low-molecular liquid crystalline compound having a polymerizable group, a photoreactive compound, and a polymerization initiator, and being of an unrewritable type.

(5) A hologram recording material described in (4), characterized in further including a sensitizing dye.

(6) A hologram recording material described in (5), characterized in that the sensitizing dye transfer an electron or energy from an excited state thereof, generated by absorption of light at holographic exposure, to the photoreactive compound so as to cause a reaction of the photoreactive compound.

(7) A hologram recording material described in any one of (4) to (6), characterized in that the photoreactive compound is a photoisomerizable compound.

(8) A hologram recording material according described in any one of (4) to (7), characterized in that the photoreactive compound is either one of an azobenzene compound, a stilbene compound, a spiropyrane compound, a spirooxazine compound, a diarylethene compound, a fulgide compound, a fulgimide compound, a cinnamic acid compound, a coumarin compound, and a calcon compound.

(9) A hologram recording material described in any one of (8), characterized in that the photoreactive compound is an azobenzene compound.

(10) A hologram recording material described in any one of (4) to (9), characterized in including a binder.

(11) A hologram recording material described in any one of (4) to (10), characterized in that the photoreactive compound is a low-molecular compound.

(12) A hologram recording material described in any one of (4) to (10), characterized in that the photoreactive compound is a high-molecular compound.

(13) A hologram recording material described in (12), characterized in that the photoreactive compound is a polymer compound in which a photoreactive site is pendant.

(14) A hologram recording material described in (10), characterized in that the binder is a polymer compound in which a photoreactive site is pendant.

(15) A hologram recording material described in any one of (4) to (14), characterized in that the low-molecular liquid crystalline compound having the polymerizable group is either one of a nematic liquid crystalline compound, a smectic liquid crystalline compound, a discotic nematic liquid crystalline compound, a discotic liquid crystalline compound, and a cholesteric liquid crystalline compound.

(16) A hologram recording material described in (15), characterized in that the low-molecular liquid crystalline compound having the polymerizable group is any one of a nematic liquid crystalline compound, a discotic nematic liquid crystalline compound, and a cholesteric liquid crystalline compound.

(17) A hologram recording material described in (16), characterized in that the low-molecular liquid crystalline compound having the polymerizable group is a nematic liquid crystalline compound.

(18) A hologram recording material described in any one of (4) to (17), characterized in that the polymerizable group described in (4) is an acryl group, a methacryl group, a styryl group, a vinyl group, an oxirane group, an oxolane group, or a vinyl ether group.

(19) A hologram recording material described in any one of (4) to (18), characterized in that the polymerization initiator described in (4) is a radical polymerization initiator, a cationic polymerization initiator or an anionic polymerization initiator.

(20) A hologram recording material described in (19), characterized in that the polymerization initiator is a radical polymerization initiator selected from a ketone, an organic peroxide, bisimidazole, a trihalomethyl-substituted triazine, a diazonium salt, a diaryliodonium salt, a sulfonium salt, an organic borate salt, a diaryliodonium-organic boron complex, a sulfonium-organic boron complex, and a metal allene complex.

(21) A hologram recording material described in (20), characterized in that the polymerization initiator is a cationic polymerization initiator (acid generating agent) selected from a trihalomethyl-substituted triazine, a diazonium salt, a diaryliodonium salt, a sulfonium salt, a metal allene complex and a sulfonic acid ester.

(22) A hologram recording material described in (19), characterized in that the polymerization initiator is an anionic polymerization initiator (base generating agent) represented by at least one of formulas (1-1) to (1-4): 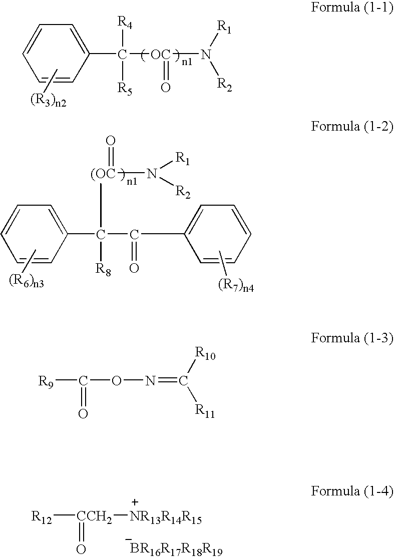
wherein, in the formulas (1-1) to (1-4), R₁, R₂, R₁₃, R₁₄ and R₁₅ each independently represents a hydrogen atom, an alkyl group, an alkenyl group, a cycloalkyl group, an aryl group or a heterocyclic group, wherein R₁ and R₂ may be mutually bonded to form a ring, and R₁₃, R₁₄ and R₁₅ may be mutually bonded to form a ring; R₃, R₆, R₇ and R₉ each independently represents a substituent; R₄, R₅, R₈, R₁₀ and R₁₁ each independently represents a hydrogen atom or a substituent, wherein R₁₀ and R₁₁ may be mutually bonded to form a ring; R₁₆, R₁₇, R₁₈ and R₁₉ each independently represents an alkyl group or an aryl group; R₁₂ represents an aryl group or a heterocyclic group; N1 represents an ingeter 0 or 1; and N2 - N4 each independently represents an integer of 0-5.

(23) A hologram recording material described in (22), characterized in that N1 is 1 in the formula (1-1) or (1-2).

(24) A hologram recording material described in (23), characterized in that, in the formula (1-1), R₃ is a nitro group substituted on 2-position or on 2- and 6-positions, or an alkoxy group substituted on 3- and 5-positions.

(25) A hologram recording material described in (22) or (23), characterized in that, in the formula (1-2), R₆ is an alkoxy group substituted on 3- and 5-positions.

(26) A hologram recording method described in any one of (1) to (3), characterized in that a hologram recording is performed on a hologram recording material having a liquid crystalline compound and described in any one of (4) to (25), at a temperature at which the liquid crystalline compound is in a liquid crystal state.

(27) A hologram recording method characterized in that a hologram recording is performed under heating a hologram recording material described in any one of (4) to (26).

(28) A hologram recording method described in any one of (1) to (3) and (26) to (27), characterized in that a hologram recording is performed on a hologram recording material having a liquid crystalline compound and described in any one of (4) to (26), by a holographic exposure followed by a flush exposure and/or a heating process.

(29) A hologram recording method characterized in performing a volume hologram recording employing a hologram recording material described in any one of (1) to (3) and (27) to (28).

(30) A hologram recording method described in (29), characterized in that a multiplex recording is performed by effecting the holographic exposure 10 times or more.

(31) A hologram recording method characterized in that a multiplex recording is performed by effecting holographic exposure 10 times or more on a hologram recording material described in any one of (4) to (25).

(32) A hologram recording method described in (30), characterized in that a common exposure amount (a constant exposure amount) is maintained in any exposure in the multiplex recording.

(33) An optical recording method employing a hologram recording method described in any one of (1) to (3) and (26) to (32).

(34) An optical recording medium employing a hologram recording material described in any one of (4) to (25).

(35) An optical recording medium characterized in that a hologram recording material described in any one of (4) to (25) is stored in a light-shielding cartridge at a storage.

(36) A three-dimensional hologram recording method employing a hologram recording method described in any one of (1) to (3) and (26) to (32).

(37) A three-dimensional hologram recording medium employing a hologram recording material described in any one of (4) to (25).

(38) A holographic optical element producing method employing a hologram recording method described in any one of (1) to (3) and (26) to (32).

(39) A holographic optical element employing a hologram recording material described in any one of (4) to (25).

A hologram recording material of the present invention enables a hologram recording based on an alignment change in a unrewritable method, and is expected for an application such as a holographic memory with satisfactory storability.

### BRIEF DESCRIPTION OF THE DRAWING

The sole Figure shows an outline view for explaining the two-beam optical system for holographic exposure. The description of numerical references in the figure is set forth below.
10 YAG laser
12 laser beam
14 mirror
20 beam splitter
22 beam segment
24 mirror
26 spatial filter
40 beam expander
30 hologram recording material
28 sample
32 He—Ne laser beam
34 H—Ne laser
36 detector
38 rotary stage

### DETAILED DESCRIPTION OF THE INVENTION

In the following there will be explained a best mode for performing the hologram recording method and the hologram recording material of the invention, with reference to the accompanying drawings.

The hologram recording method of the invention is characterized in causing a change in an alignment of a compound having a specific birefringence upon holographic exposure and fixing the alignment of the comound by a chemical reaction, so as to record unrewritable interference fringes providing a modulation in refractive index.

The “unrewritable” recording means a recording by an irreversible reaction, wherein once recorded data can be stored without being rewritten by an overwriting, and is therefore suitable for storage of data that are important and require a prolonged storage. It is however naturally possible to add a recording in an unrecorded area, and, in such sense, such method is called “add-on” type or “write once” type.

A compound having a specific birefringence means a compound in which a refractive index (Ne) specific to the molecule in a long-axis direction is different from a refractive index (Nₒ) in a short-axis direction. The specific birefringence means a birefringence specific to the molecule, and can be determined from a birefringence in a bulk state such as a solid or a liquid crystal state, or by a molecular orbital calculation. As the hologram recording method of the invention is based on an alignment control of a compound having a specific birefringence by holographic exposure recording a change in the refractive index, the compound having a specific birefringence has a refractive index anisotropy ΔN═|Nₑ—Nₒ| as large as possible, preferably 0.01 or larger, more preferably 0.05 or larger and most preferably 0.1 or larger.

Therefore, the compound having a specific birefringence of the invention is preferably a rod-shaped compound in which a conjugation is linearly linked in the long-axis direction of the molecule.

The compound having a specific birefringence of the invention is preferably so-called dichroic compound (dye) or a liquid crystalline compound, more preferably a liquid crystalline compound, further preferably a low-molecular liquid crystalline compound, and most preferably a low-molecular liquid crystalline compound having at least two rings in a core part.

The compound having a specific birefringence of the invention, preferably a liquid crystalline compound, is preferably is fixed in the alignment after the alignment is changed upon holographic exposure. Therefore the compound having a specific birefringence of the invention, preferably a liquid crystalline compound, preferably has a reactive group and can fix the alignment by a chemical reaction in the holographic exposure or in a process thereafter. The chemical reaction is preferably an irreversible reaction, and preferably an addition reaction, a ring-opening addition reaction, a condensation reaction, a ring-opening condensation reaction, a cyclizing reaction, a nucleophilic reaction, an electrophilic reaction, a radical reaction, or a complexing reaction.

In the invention, the chemical reaction is more preferably a polymerization reaction. The polymerization reaction can be an addition polymerization reaction, a ring-opening addition polymerization reaction, a condensation polymerization reaction, a ring-opening condensation polymerization reaction, or a complexing reaction, more preferably an addition polymerization reaction or a ring-opening addition polymerization reaction. It is preferred that, at such reaction, there takes place a radical polymerization reaction, a cationic polymerization reaction, or an anionic polymerization reaction.

Therefore, the compound having a specific birefringence of the invention, preferably a liquid crystalline compound, or more preferably a low-molecular liquid crystalline compound preferably has a polymerizable group and more preferably is fixed by a polymerization reaction. The polymerizable group is preferably an acryl group, a methacryl group, a styryl group, a vinyl group, an oxirane group, an oxolane group, or a vinyl ether group.

The liquid crystalline compound of the invention is preferably any one of a nematic liquid crystalline compound, a smectic liquid crystalline compound, a discotic nematic liquid crystalline compound, a discotic liquid crystalline compound, and a cholesteric liquid crystalline compound, more preferably any one of a nematic liquid crystalline compound, a discotic nematic liquid crystalline compound, and a cholesteric liquid crystalline compound, and more preferably a nematic liquid crystalline compound.

Therefore the liquid crystalline compound of the invention is more preferably a low-molecular liquid crystalline compound having a polymerizable group and capable of assuming a phase as mentioned above.

A hologram recording on a hologram recording material including the liquid crystalline compound of the invention is preferably conducted at a temperature where the liquid crystalline compound is in a liquid crystal state, and, in case such temperature is higher than the room temperature, it is also preferable to perform the hologram recording under heating of the hologram recording material.

The hologram recording material of the invention preferably includes at least a low-molecular liquid crystalline compound having a polymerizable group, a photoreactive compound and a polymerization initiator.

The photoreactive compound of the invention means a compound capable of a reaction in an excited state thereof, generated by optical absorption, to cause a structural change, thereby causing a change in the alignment of the liquid crystalline compound or preferably the low-molecular liquid crystalline compound having a polymerizable group, and thus achieving a modulation in the refractive index. A photoreaction induced by the photoreactive compound can be an isomerizing reaction, a two-molecular cyclizing reaction, a ring-closing reaction, a ring-opening reaction, an addition reaction, a liberation reaction, a condensation reaction, a solvation reaction, a nucleophilic reaction, an electrophilic reaction, a radical reaction, or a complexing reaction, poreferably an isomerizing reaction, a two-molecular cyclizing reaction, a ring-closing reaction or a ring-opening reaction.

A photoreactive compound capable of an isomerizing reaction can preferably be an azobenzene compound or a stilbene compound; a compound capable of a two-molecular cyclizing reaction can preferably be a cinnamic acid compound, a coumarin compound or a calcon compound; a compound capable of a ring-opening reaction can preferably be a spiropyran compound, or a spirooxazine compound; and a compound capable of a ring-closing reaction can preferably be a diarylethene compound, a fulgide compound or a fulgimide compound.

The photoreactive compound of the invention is more preferably a photoisomerizable compound, and more preferably an azobenzene compound.

The photoisomerizable compound can be a low-molecular compound or a high-molecular compound, and, in case of a high-molecular compound, it is more preferably a polymer compound in which a photoreactive site is pendant.

It is also preferable that the hologram recording material of the invention includes a sensitizing dye, in addition to the photoreactive compound. In such case, it is preferable that the sensitizing dye absorbs a light at the holographic exposure to generate an excited state thereof and an electron transfer or an energy transfer from such excited state causes a reaction of the photoreactive compound. In case the hologram recording material of the invention includes a sensitizing dye, it is also preferable that the hologram recording material includes an electron donating compound capable of reducing a radical cation of the sensitizing dye or an electron accepting compound capable of oxidizing a radical anion of the sensitizing dye.

The hologram recording material of the invention preferably includes a polymerization initiator. The polymerization initiator is preferably can be a radical polymerization initiator generating a radical, a cationic polymerization initiator generating an acid, or an anionic polymerization initiator generating a base.

The polymerization initiator of the invention generates a radical, an acid or a base preferably by an energy transfer or an electron transfer from an excited state of the sensitizing dye or the photoreactive compound or by a direct excitation.

It is also preferable that the hologram recording material of the invention includes a binder (polymer matrix compound), in addition to the low-molecular liquid crystalline compound, the photoreactive compound, the polymerization initiator and the sensitizing dye. The binder is employed for the purpose of increasing a film strength or improving a film forming property. In case the photoreactive compound is constituted of a polymer compound, particularly a polymer compound in which a photoreactive site is pendant, such photoreactive compound may advantageously serve as a binder.

The hologram recording material of the invention may further include, if necessary, additives such as a polymerizable monomer, a polymerizable oligomer, a crosslinking agent, a thermal stabilizer, a plasticizer, and a solvent.

However, in the hologram recording material of the invention, the interference fringe recording (refractive index modulation) itself does not necessarily require such binder, polymerizable monomer, polymerizable oligomer and the like, which are employed for the purposes of a film curing, an improvement in the film forming property, an improvement in the storability and a reduction in the shrinkage.

In the hologram recording material of the invention, a wet processing is preferably not performed after the holographic exposure.

The hologram recording material of the invention is a recording material for preferably performing a hologram recording of volume phase type. The hologram recording of volume phase type is to record a plurality of interference fringes, by a refractive index modulation, in a form parallel or substantially parallel to the film surface of the recording material (reflective type) or in a form perpendicular or substantially perpendicular to the film susface of the recording material (transmission type), with a pitch of 1000-7000 fringes per millimeter in the direction of thickness of the film.

The hologram recording material of the invention may be subjected, after the holographic exposure, to a fixing step by light and/or heat.

In case of a photofixing, an entire area of the hologram recording material is flush irradiated (non-holographic exposure, i.e., non-interfering exposure) with an ultraviolet light or a visible light. A light source to be employed for this purpose is preferably a visible light laser, an ultraviolet light laser, a carbon arc lamp, a high-pressure mercury lamp, a xenon lamp, a metal halide lamp, a fluorescent lamp, a tungsten lamp, an LED or an organic EL.

In case of a thermal fixing, a fixing step is preferably performed at 40-160° C., more preferably 60-130° C.

In case of employing both photofixing and thermal fixing, light and heat may be applied simultaneously or separately.

In the interference fringe recording, a modulation in the refractive index is preferably 0.00001-0.5 and more preferably 0.0001-0.3.

A diffraction efficiency η of the hologram recording material is given by a following equation:
η=I_{diff}/I₀ (1)
wherein I₀ is an intensity of an incident light, and I_{diff} is an intensity of a diffracted light (transmission type) or a reflected light (reflective type). The diffraction efficiency assumes a value within a range of 0-100%, but is preferably 30% or higher, more preferably 60% or higher and most preferably 80% or higher.

A light to be employed in the invention is preferably an ultraviolet light, a visible light or an infrared light of a wavelength of 200-2000 nm, more preferably an ultraviolet light or a visible light of a wavelength of 300-700 nm, and further preferably a visible light of a wavelength of 400-700 nm.

Also the light to be employed in the invention is preferably a coherent (aligned in phase and wavelength) laser light. A laser to be employed can be a solid laser, a semiconductor laser, a gas laser or a liquid laser, and a preferable laser light is for example a second harmonic wave of a YAG laser at 532 nm, a third harmonic wave of a YAG laser at 355 nm, a GaN laser light of 405-415 nm, an Ar ion laser light of 488 nm or 515 nm, a He—Ne laser light of 632 nm or 633 nm, a Kr ion laser light of 647 nm, a ruby laser light of 694 nm or a He—Cd laser light of 636, 634, 538, 534 or 442 nm.

Also a pulsed laser of a nanosecond or picosecond order is advantageously employed.

In case of utilizing the hologram recording material of the invention for an optical recording material, there is preferably employed a second harmonic wave of a YAG laser of 532 nm or a GaN laser light of about 405-415 nm.

The light to be employed for hologram reproduction preferably has a wavelength same as or longer than the wavelength of the light employed for holographic exposure (recording), more preferably a same wavelength.

A sensitivity of the hologram recording material is generally represented by an exposure amount per unit area (mJ/cm²), and a smaller value can be considered to indicate a higher sensitivity. However, a stage of the exposure amount selected for representing the sensitivity is variable in various literatures, patents and the like, such as an exposure amount when a recording (refractive index modulation) is initiated, an exposure amount giving a maximum diffraction efficiency (maximum refractive index modulation), an exposure amount giving a diffraction efficiency equal to a half of the a maximum diffraction efficiency, or an exposure amount giving a maximum slope of the diffraction efficiency as a function of an exposure amount E.

Also according to Kugelnik's theory, an amount ΔN of refractive index modulation for providing a certain diffraction efficiency is inversely proportional to a film thickness d. Therefore a sensitivity for obtaining a certain diffraction efficiency is variable also depending on the film thickness, and a smaller amount ΔN of refractive index modulation can be used for a larger film thickness d. Thus, the sensitivity cannot be compared in a simple manner unless conditions such as a film thickness are matched.

In the invention, the sensitivity is defined as “an exposure amount (mJ/cm²) giving a diffraction efficiency equal to a half of the a maximum diffraction efficiency”. The hologram recording material of the invention, for example for a film thickness of about 10-200 μm, preferably has a sensitivity of 2 J/cm² or less, more preferably 1 J/cm² or less, further preferably 500 mJ/cm² or less, and most preferably 200 mJ/cm² or less.

In case of utilizing the hologram recording material of the invention as an optical recording medium for a holographic memory, it is preferable to record a plurality of two-dimensional digital information (called signal light), utilizing a spatial light modulator (SLM) such as a DMD or an LCD. For increasing the recording density, the recording is preferably performed by a multiplex recording, which can be performed for example by an angular multiplexing, a phase multiplexing, a wavelength multiplexing or a shift multiplexing, among which an angular multiplex recording or a shift multiplex recording is preferably employed. Also for reading the reproduced two-dimensional data, a CCD or a CMOS sensor is preferably employed.

In case of utilizing the hologram recording material of the invention as an optical recording medium, it is essential to perform a multiplex recording for increasing the capacity (recording density). It is preferable to perform recordings of 10 times or more, more preferably 50 times or more and further preferably 100 times or more. Also it is preferable that the multiplex recording can be performed with a constant exposure amount in any recording in simplifying the recording system and improving the S/N ratio.

In the following each component of the hologram recording material of the invention will be explained in detail.

In the invention, when a specified portion is called a “group”, it means that such group may be substituted with one or more (up to maximum possible) substituents or may not be substituted, unless specified otherwise. For example an “alkyl group” means a substituted or non-substituted alkyl group. Also a substituent employable in the compound of the invention may be any substituent.

Also in the invention, when a specified portion is called a “ring”, or in case a “ring” is included in a “group”, such ring may be a single ring or a condensed ring unless specified otherwise, and may be substituted or non-substituted.

For example, an “aryl group” may be a phenyl group or a naphthyl group, or a substituted phenyl group.

At first there will be explained the liquid crystalline compound of the invention.

As explained in the foregoing, the liquid crystalline compound of the invention is preferably a low-molecular liquid crystalline compound, and more preferably a low-molecular liquid crystalline compound having two more rings in a core part.

Further, the liquid crystalline compound of the invention preferably has a reactive group, and more preferably a polymerizable group. Therefore, the liquid crystalline compound of the invention is more preferably a low-molecular liquid crystalline compound having a polymerizable group.

The molecular weight of the low-molecular liquid crystalline compound is preferably 1,000 or less, more preferably 500 or less.

The low-molecular liquid crystalline compound having a polymerizable group of the invention is preferably represented by formula (2).

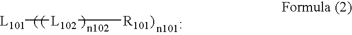

In the formula (2), L₁₀₁ represents a liquid crystalline core part, of which examples are described in Mitsuharu Okano and Shunsuke Kobayashi, “Basics of Liquid Crystal”, Baihu-kan (1985) and “Kagaku Sosetsu No. 22, Chemistry of Liquid Crystal”, 1994, and which are preferably represented in the invention by following formulas, in which a line extending from a liquid crystalline core part represents a substituting position. However, a substituent may be provided in a position other than the position of the line.

Examples of Liquid Crystalline Core Part:

<Examples of Core Part Having Nematic or Smectic Liquid Crystalline Property> 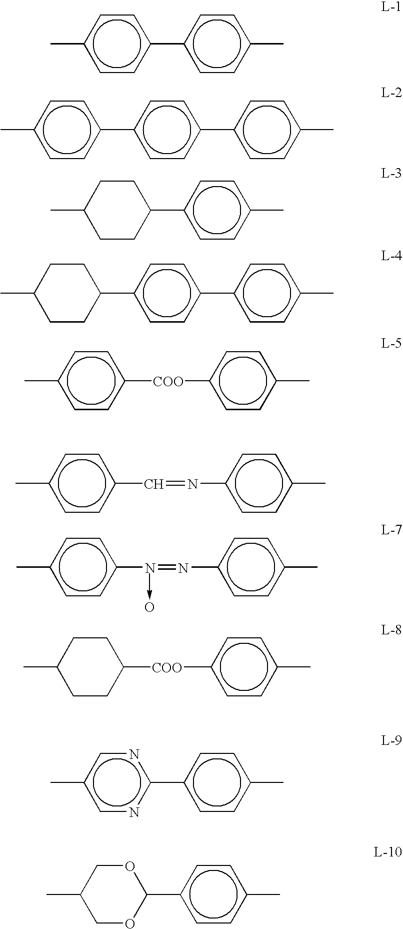
<Examples of Core Part Having Cholesteric Liquid Crystalline Property> 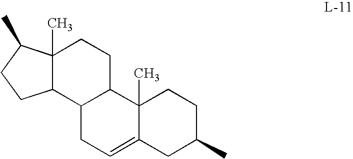
<Examples of Core Part Having Discotic Liquid Crystalline Property or Discotic Nematic Liquid Crystalline Property>

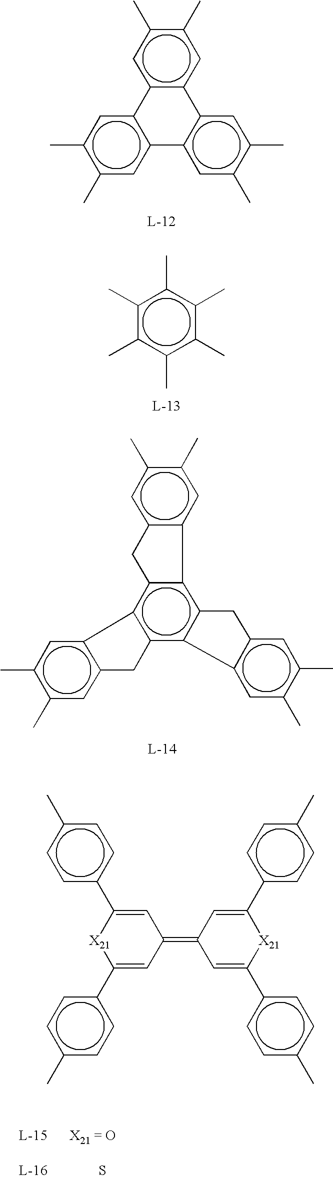

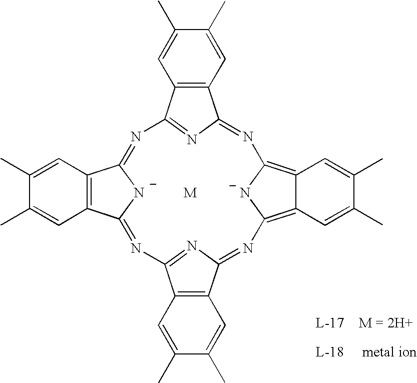

In the liquid crystalline core part, for promoting the liquid crystalline property, there may be provided an alkyl group (preferably with 1-20 carbon atoms (hereinafter represented as C number) such as methyl, ethyl, n-propyl, n-butyl, n-pentyl, n-hexyl or benzyl), an alkenyl group (preferably with C number of 2-20 such as vinyl, allyl, 2-butenyl or 1,3-butadienyl), an alkinyl group (preferably with C number of 2-20, such as ethinyl, 2-propinyl, 1,3-butadiinyl, or 2-phenylethinyl), a cyano group, a nitro group, a halogen atom (such as F, Cl, Br or I), an alkoxy group (preferably with C number of 1-20, such as methoxy, or ethoxy), an acylamino group (preferably with C number 1-20, such as acetylamino or benzoylamino), or an amino group (preferably with C number of 1-20, such as dimethylamino, diethylamino or dibutylamino), in one unit or in plural units.

The liquid crystalline core part of the invention preferably has a nematic liquid crystalline property, a smectic liquid crystalline property, a discotic nematic liquid crystalline property, a discotic liquid crystalline property, or a cholesteric liquid crystalline property, more preferably a nematic liquid crystalline property, a discotic nematic liquid crystalline property, or a cholesteric liquid crystalline property, and further preferably a nematic liquid crystalline property.

In the formula (2), R₁₀₁ represents a polymerizable group or a hydrogen atom, preferably an acryl group, a methacryl group, a styryl group, a vinyl group, an oxirane group, an oxolane group, a vinyl ether group or a hydrogen atom, and more preferably an acryl group, a methacryl group, an oxirane group or an oxolane group.

In the formula (2), L₁₀₂ represents a connecting group, and is preferably a connecting group formed by an alkylene group (preferably with C number of 1-20, such as methylene, ethylene, propylene, butylenes, pentylene, hexylene or octylene), an alkenylene group (preferably with C number of 2-20, such as ethenylene, propenylene, butenylene, or butadienylene), an alkinylene group (preferably with C number of 2-20, such as ethinylene or butadiinylene), an arylene group (preferably with C number of 6-26, such as 1,4-phenylene, 1,4-naphthylene or 2,6-naphthylene), a heterylene group (preferably with C number of 1-20, such as 2,5-thienylene, 2,5-pyrrolylene, 2,5-pyridinylene or 2,5-pyrimidinylene), —O—, —S—, —NR₁₀₂—, —COO—, or —CONR₁₀₃—, either singly or by a combination of plural units. R₁₀₂ and R₁₀₃ each independently represents a hydrogen atom, an alkyl group (preferably with C number of 1-20, such as methyl, ethyl, or benzyl), an alkenyl group (preferably with C number of 2-20, such as vinyl or allyl), a cycloalkyl group (preferably with C number of 3-20, such as cyclohexyl or cyclopentyl), an aryl group (preferably with C number of 6-20, such as phenyl or 2-naphthyl), or a heterocyclic group (preferably with C number of 1-20, such as 2-thienyl, 2-pyridinyl or 2-pyrimidinyl).

In the formula (2), n101 represents an integer of 1-8, and is preferably 1 or 2 in case L₁₀₁ is a nematic liquid crystalline core part, a smectic liquid crystalline core part, or a cholesteric liquid crystalline core part, and is preferably an integer of 3-8 in case L₁₀₁ is a discotic nematic liquid crystalline core part, or a discotic liquid crystalline core part.

n₁₀₂ represents 0 or 1.

The compound represented by the formula (2) includes at least a polymerizable group.

In the following, there will be shown specific examples of the liquid crystalline compound having the polymerizable group in the invention, represented by the formula (2), but the present invention is not limited to such examples.

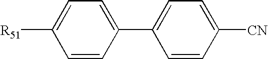

| | R₅₁ |
|---|---|
| LC-1 | 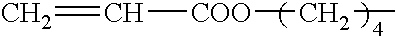 |
| LC-2 | 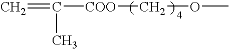 |
| LC-3 | 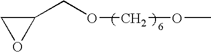 |

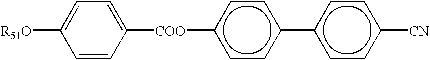

| | R₅₁ |
|---|---|
| LC-4 | 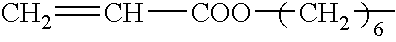 |
| LC-5 | 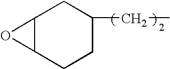 |

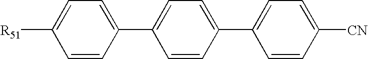

| | R₅₁ |
|---|---|
| LC-6 | 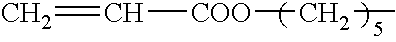 |
| LC-7 | 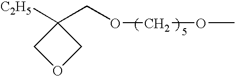 |

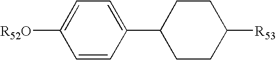

| | R₅₂ | R₅₃ |
|---|---|---|
| LC-8 | 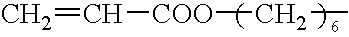 | 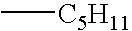 |
| LC-9 | 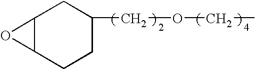 | — |
| LC-10 | 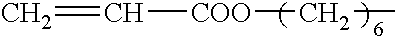 | 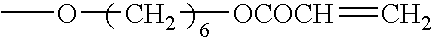 |
| LC-11 | 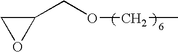 | 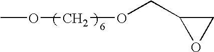 |

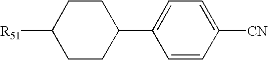

| | R₅₁ |
|---|---|
| LC-12 | 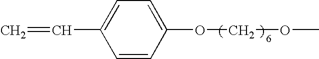 |
| LC-13 | 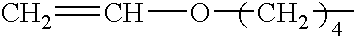 |

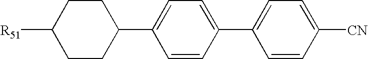

| | R₅₁ |
|---|---|
| LC-14 | 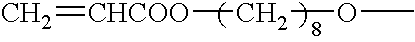 |
| LC-15 | 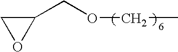 |

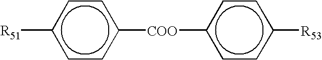

| | R₅₁ | R₅₃ |
|---|---|---|
| LC-16 | 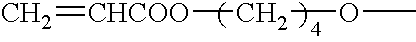 | 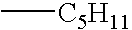 |
| LC-17 | 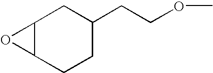 | — |
| LC-18 | 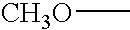 | 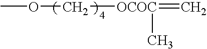 |
| LC-19 | 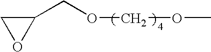 | 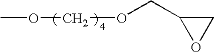 |
| LC-20 | 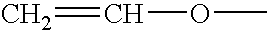 | 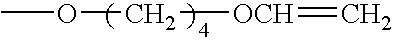 |
| LC-21 | 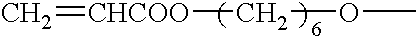 | 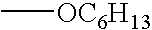 |
| LC-22 | 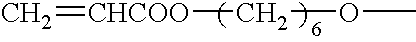 | 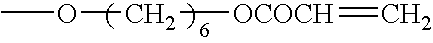 |

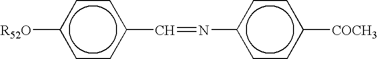

| | R₅₂ |
|---|---|
| LC-23 | 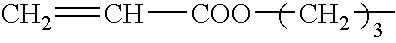 |
| LC-24 | 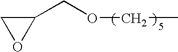 |

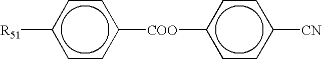

| | R₅₁ |
|---|---|
| LC-25 | 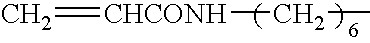 |
| LC-26 | 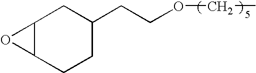 |

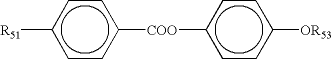

| | R₅₁ | R₅₃ |
|---|---|---|
| LC-27 | 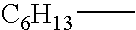 | 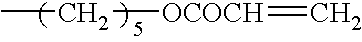 |
| LC-28 | 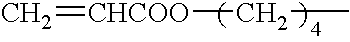 | 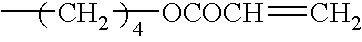 |
| LC-29 | 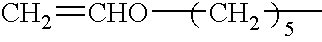 | 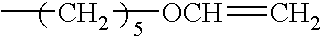 |

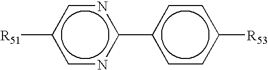

| | R₅₁ | R₅₃ |
|---|---|---|
| LC-30 | 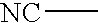 | 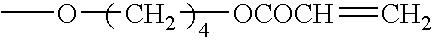 |
| LC-31 | 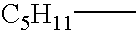 | 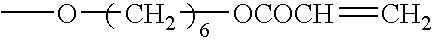 |
| LC-32 | 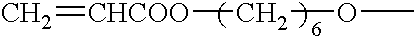 | 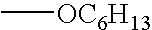 |
| LC-33 | 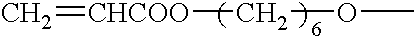 | 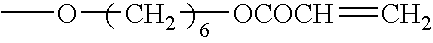 |
| LC-34 | 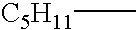 | 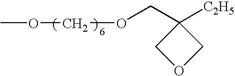 |
| LC-35 | 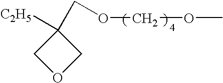 | 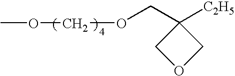 |

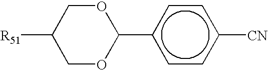

| | R₅₁ |
|---|---|
| LC-36 | 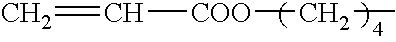 |
| LC-37 | 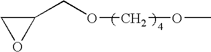 |

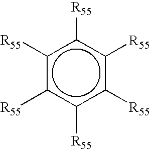

| | R₅₅ |
|---|---|
| LC-38 | 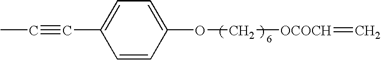 |
| LC-39 | 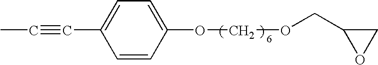 |

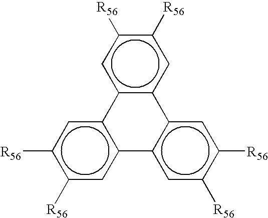

| | R₅₆ |
|---|---|
| LC-40 | 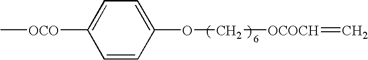 |
| LC-41 | 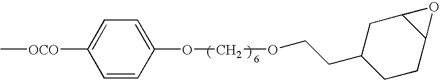 |
| LC-42 | 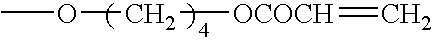 |
| LC-43 | 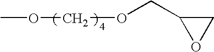 |
| LC-44 | 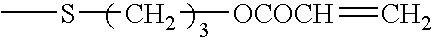 |
| LC-45 | 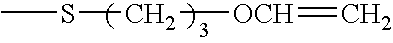 |

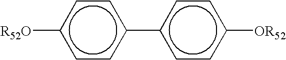

| | R₅₂ |
|---|---|
| LC-46 | 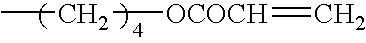 |
| LC-47 | 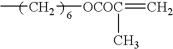 |
| LC-48 | 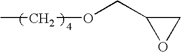 |
| LC-49 | 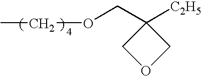 |

The liquid crystalline compound of the invention can be synthesized for example based on methods described in Mitsuharu Okano and Shunsuke Kobayashi, “Basics of Liquid Crystal”, Baihu-kan (1985) and “Kagaku Sosetsu No. 22, Chemistry of Liquid Crystal”, 1994.

In the following the photoreactive compound to be employed in the invention will be explained in detail.

A photoreactive compound capable of an isomerizing reaction can preferably be an azobenzene compound or a stilbene compound; a compound capable of a two-molecular cyclizing reaction can preferably be a cinnamic acid compound, a coumarin compound or a calcon compound; a compound capable of a ring-opening reaction can preferably be a spiropyran compound, or a spirooxazine compound; and a compound capable of a ring-closing reaction can preferably be a diarylethene compound, a fulgide compound or a fulgimide compound.

The photoreactive compound of the invention is more preferably a photoisomerizable compound, and more preferably an azobenzene compound.

The photoisomerizable compound can be a low-molecular compound or a high-molecular compound, and, in case of a high-molecular compound, it is more preferably a polymer compound in which a photoreactive site is pendant.

In the following, there will be shown specific examples of the photoreactive compound of the invention, but the present invention is not limited to such examples.

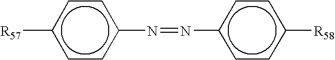

| | R₅₇ | R₅₈ |
|---|---|---|
| R-1 | H | H |
| R-2 | 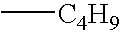 | 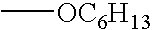 |
| R-3 | 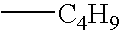 | 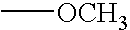 |
| R-4 | 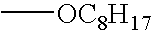 | 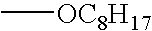 |
| R-5 | 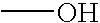 | H |
| R-6 | 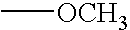 | 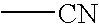 |
| R-7 | 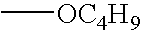 | 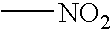 |
| R-8 | 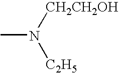 | 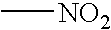 |

| | |
|---|---|
| R-9 | 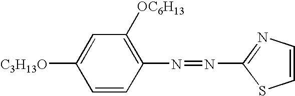 |
| R-10 | 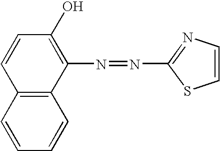 |
| R-11 | 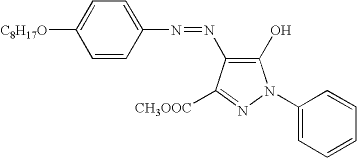 |
| R-12 | 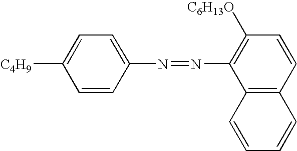 |
| R-13 | 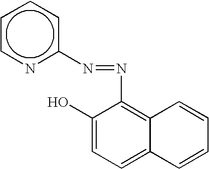 |
| R-14 | 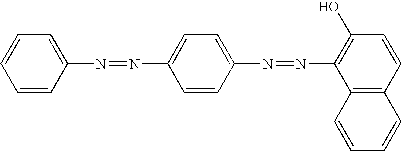 |
| R-15 | 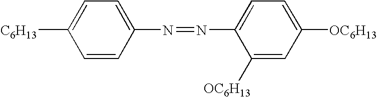 |
| R-16 | 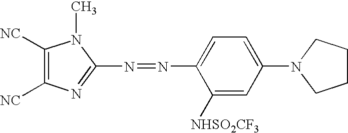 |
| R-17 | 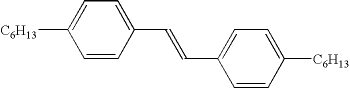 |
| R-18 | 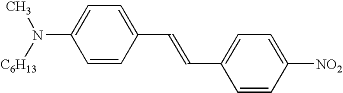 |
| R-19 | 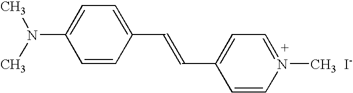 |
| R-20 | 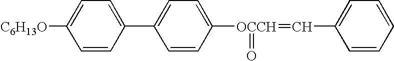 |
| R-21 | 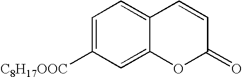 |
| R-22 | 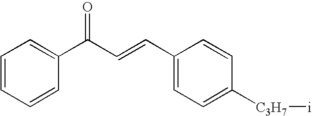 |
| R-23 | 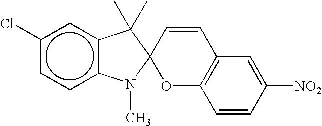 |
| R-24 | 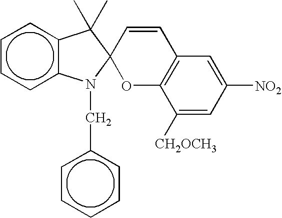 |

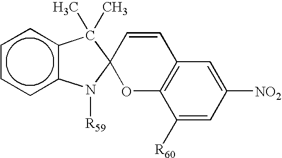

| | R₅₉ | R₆₀ |
|---|---|---|
| R-25 | C₁₂H₂₅ | H |
| R-26 | C₁₈H₃₇ | H |
| R-27 | CH₃ | OCH₃ |

| | |
|---|---|
| R-28 | 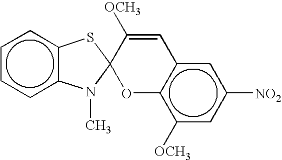 |
| R-29 | 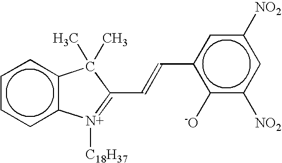 |
| R-30 | 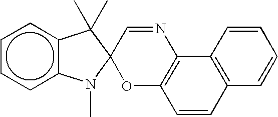 |

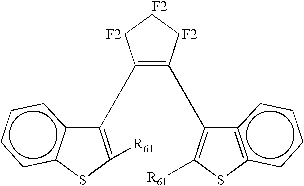

| | R₆₁ |
|---|---|
| R-31 | H |
| R-32 | CH₃ |

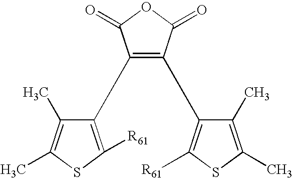

| | R₆₁ |
|---|---|
| R-33 | H |
| R-34 | CH₃ |
| R-35 | 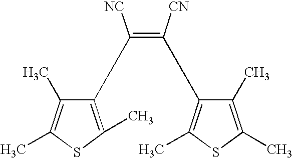 |
| R-36 | 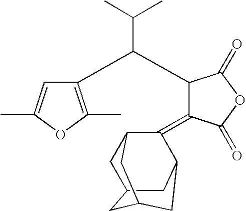 |

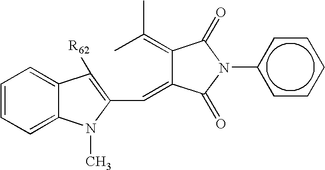

| | R₆₂ |
|---|---|
| R-37 | H |
| R-38 | CH₃ |

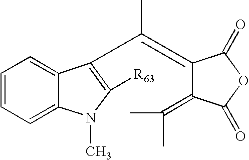

| | R₆₃ |
|---|---|
| R-39 | H |
| R-40 | CH₃ |
| R-41 | 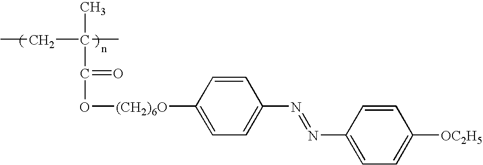 |
| R-42 | 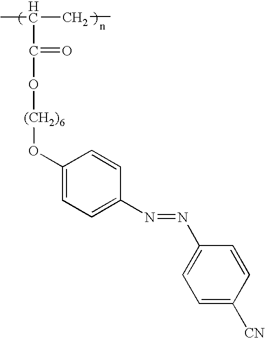 |

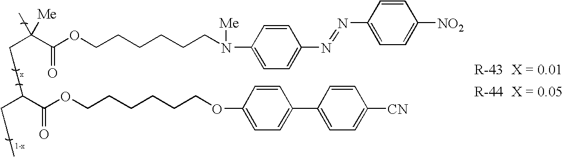

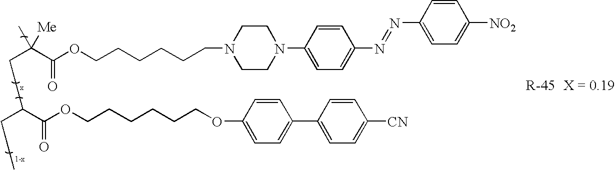

| | |
|---|---|
| R-46 | 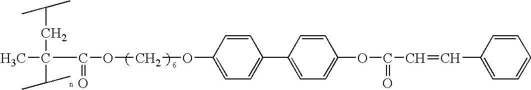 |
| R-47 | 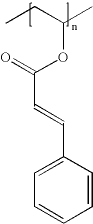 |

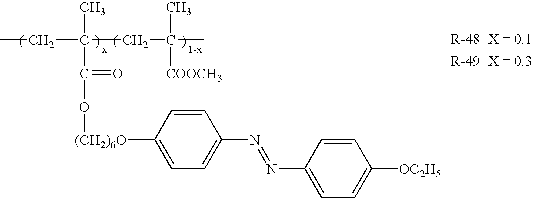

The photoreactive compound to be employed in the invention is commercially available or can be synthesized by a known method.

In the following, the sensitizing dye of the invention will be explained.

In case of employing a sensitizing dye in addition to the photoreactive compound in the invention, it is preferred that the sensitizing dye absorbs the light at the holographic exposure to generated an excited state thereof and a reaction of the photoreactive compound is induced by an electron transfer or an energy transfer from thus generated excited state.

In case of utilizing an energy transfer mechanism from the excited state of the sensitizing dye, there can be utilized a Foerster mechanism in which the energy transfer takes place from a singlet excited state of the sensitizing dye or a Dexter mechanism in which the energy transfer takes place from a triplet excited state of the sensitizing dye.

In order to achieve an efficient energy transfer, the excitation energy of the sensitizing dye is preferably larger than that of the photoreactive compound.

On the other hand, in case of an electron transfer mechanism from the excited state of the sensitizing dye, there can be utilized a mechanism in which the electron transfer takes place from a singlet excited state of the sensitizing dye or a mechanism in which the electron transfer takes place from a triplet excited state of the sensitizing dye.

Also the sensitizing dye in the excited state may donate an electron to the photoreactive compound or may receive an electron therefrom. In case of an electron donation from the excited state of the sensitizing dye, in order to achieve an efficient electron transfer, an energy of a molecular orbit (LUMO: lowest unoccupied molecular orbit), in which an excited electron of the excited state of the sensitizing dye exists, is preferably larger than an energy of a LUMO orbit of the photoreactive compound.

In case of an electron reception by the excited state of the sensitizing dye, in order to achieve an efficient electron transfer, an energy of a molecular orbit (HOMO: highest occupied molecular orbit), in which a hole in the excited state of the sensitizing dye exists, is preferably larger than an energy of a HOMO orbit of the photoreactive compound.

The sensitizing dye of the invention preferably generates an excited state thereof by absorbing an ultraviolet light, a visible light or an infrared light of a wavelength of 200-2000 nm, preferably generates an excited state thereof by absorbing an ultraviolet light or a visible light of a wavelength of 300-700 nm, and most preferably generates an excited state thereof by absorbing a visible light of a wavelength of 400-700 nm.

The sensitizing dye of the invention is preferably a cyanine dye, a squarilium cyanine dye, a styryl dye, a pyrilium dye, a merocyanine dye, an arylidene dye, an oxonol dye, an azulenium dye, a coumarin dye, a ketocoumarin dye, a styrylcoumarin dye, a pyran dye, a xanthene dye, a thioxanthene dye, a phenothiazine dye, a phenoxazine dye, a phenazine dye, a phthalocyanine dye, an azaporphiline dye, a porphiline dye, a condensed-ring aromatic dye, a perylene dye, an azomethine dye, an anthraquinone dye, a metal complex dye, or a metallocene dye, more preferably a cyanine dye, a squarilium cyanine dye, a pyrilium dye, a merocyanine dye, an oxonol dye, a coumarin dye, a ketocoumarin dye, a styrylcoumarin dye, a pyran dye, a xanthene dye, a thioxanthene dye, a condensed-ring aromatic dye, a metal complex dye, or a metallocene dye, and further preferably a cyanine dye, a merocyanine dye, an oxonol dye, a metal complex dye, or a metallocene dye. The metal complex dye is particularly preferably a Ru complex dye, and the metallocene dye is particularly preferably a ferrocene.

Also dyes described in “Dye Handbook” (Shinya Ogawara, Kodan-sha, 1986), “Chemistry of Functional Dyes” (Shinya Ogawara, CMC, 1981), and “Special Functional Materials” (Chuzaburo Ikemori et al., CMC, 1986) may be employed as the sensitizing dye of the invention. The sensitizing dye of the invention is not limited to such examples but can be any dye showing an absorption to the light in the visible region. Such sensitizing dye may be selected so as to match the wavelength of the laser employed as the light source according to the purpose of use, and, depending on the purpose, two or more sensitizing dyes may be employed in combination.

In the following specific examples of the sensitizing dye of the invention will be shown, but the present invention is not limited to such examples.

<cyanine dye>

| | |
|---|---|
| D-1 | 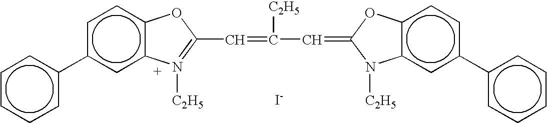 |
| D-2 | 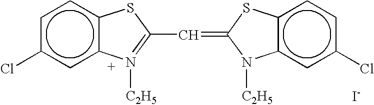 |
| D-3 | 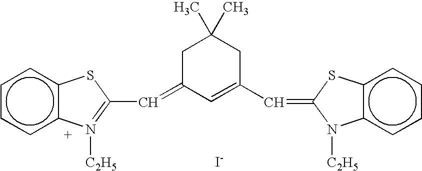 |
| D-4 | 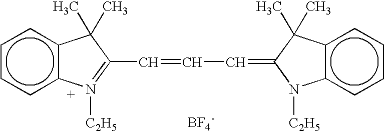 |
| D-5 | 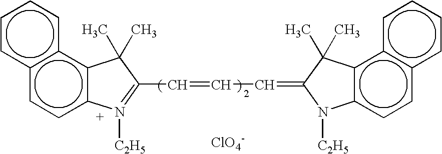 |
| D-6 | 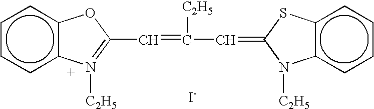 |
| D-7 | 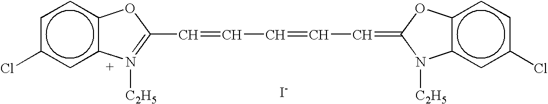 |
| D-8 | 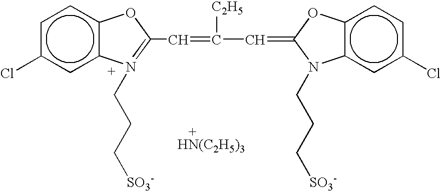 |
| D-9 | 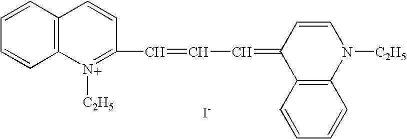 |

<squarilium cyanine dye>

| | |
|---|---|
| D-10 | 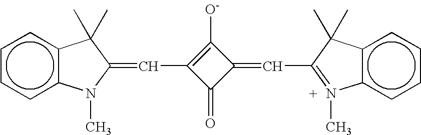 |
| D-11 | 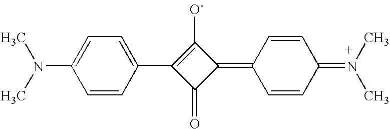 |

<styryl dye>

| | |
|---|---|
| D-12 | 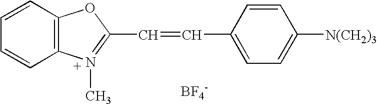 |
| D-13 | 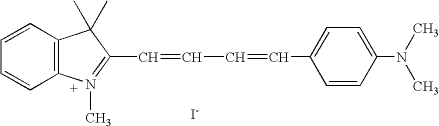 |

<pyrilium dye>

| | |
|---|---|
| D-14 | 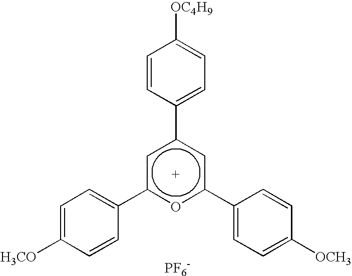 |
| D-15 | 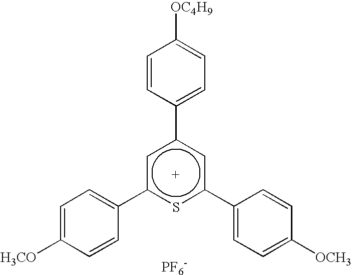 |

<merocyanine dye>

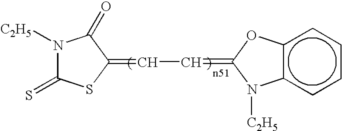

| | n51 |
|---|---|
| D-16 | 0 |
| D-17 | 1 |
| D-18 | 2 |
| D-19 | 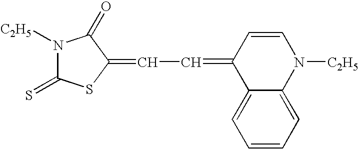 |

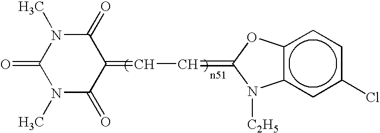

| | n51 |
|---|---|
| D-20 | 1 |
| D-21 | 2 |

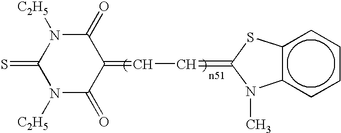

| | n51 |
|---|---|
| D-22 | 1 |
| D-23 | 2 |
| D-24 | 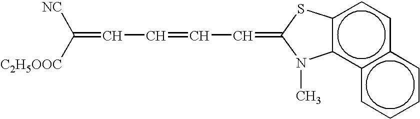 |

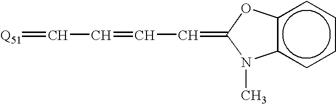

| | Q₅₁ |
|---|---|
| D-25 | 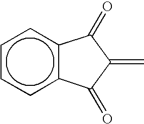 |
| D-26 | 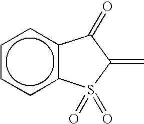 |
| D-27 | 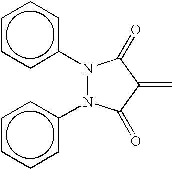 |
| D-28 | 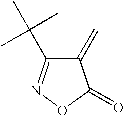 |
| D-29 | 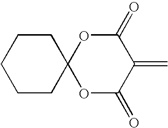 |

<continuation of merocyanine dye>

| | |
|---|---|
| D-30 | 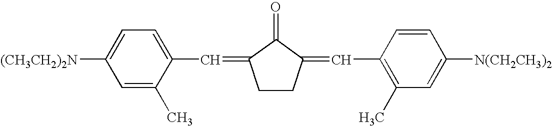 |
| D-31 | 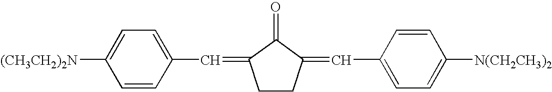 |
| D-32 | 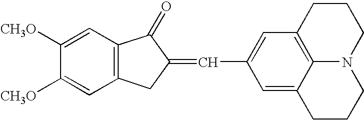 |
| D-33 | 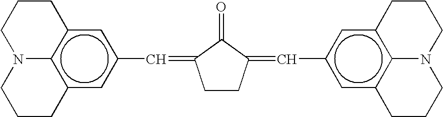 |
| D-34 | 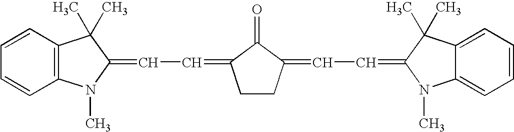 |
| D-35 | 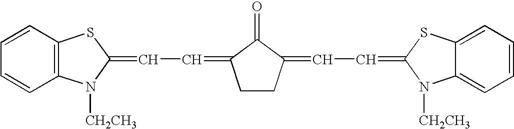 |
| D-36 | 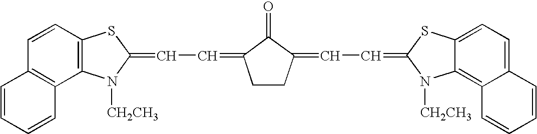 |

<arylidene dye>

| | |
|---|---|
| D-37 | 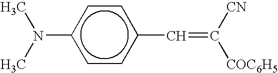 |
| D-38 | 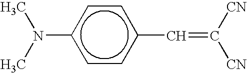 |
| D-39 | 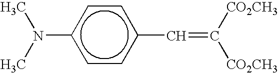 |
| D-40 | 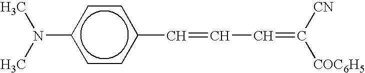 |

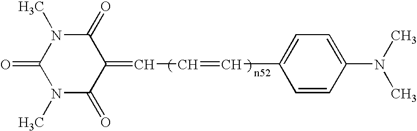

| | n52 |
|---|---|
| D-41 | 0 |
| D-42 | 1 |

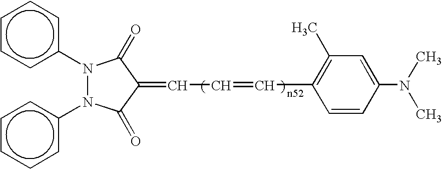

| | n52 |
|---|---|
| D-43 | 0 |
| D-44 | 1 |

(oxonol dye)

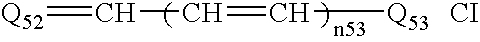

| | Q₅₂ | Q₅₃ | n₅₃ | CI |
|---|---|---|---|---|
| D-45 | 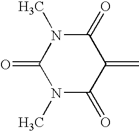 | 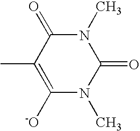 | 2 | H⁺ |
| D-46 | 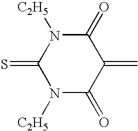 | 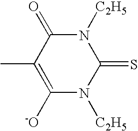 | 1 | 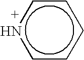 |
| D-47 | — | — | 2 | 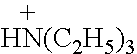 |
| D-48 | 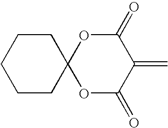 | 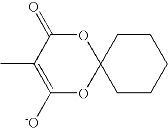 | 2 | H⁺ |
| D-49 | 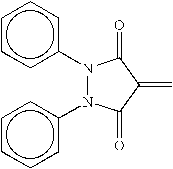 | 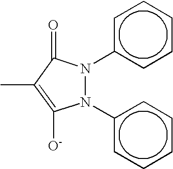 | 1 | H⁺ |
| D-50 | 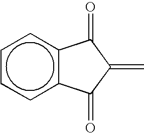 | 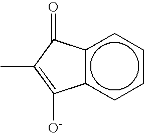 | 1 | 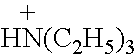 |
| D-51 | 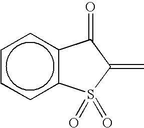 | 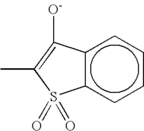 | 2 | — |

<azulenium dye>

| | |
|---|---|
| D-52 | 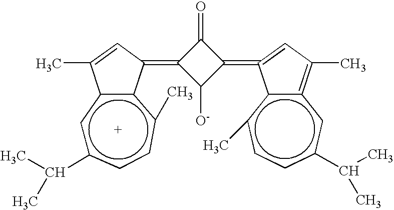 |

<coumarin dye>

| | |
|---|---|
| D-53 | 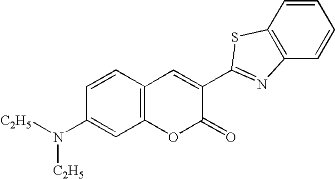 |
| D-54 | 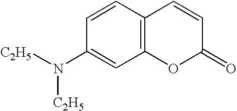 |

<ketocoumarin dye>

| | |
|---|---|
| D-55 | 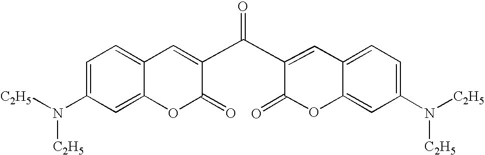 |
| D-56 | 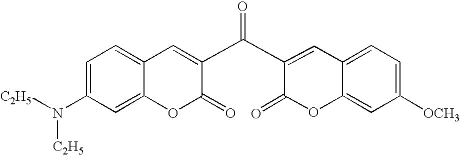 |
| D-57 | 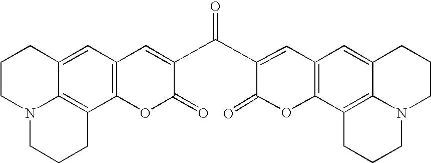 |
| D-58 | 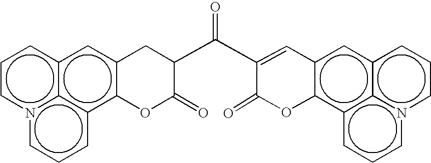 |
| D-59 | 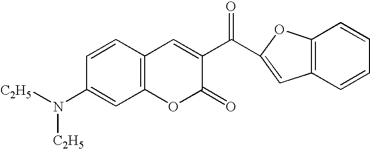 |

<styrylcoumarin dye>

| | |
|---|---|
| D-60 | 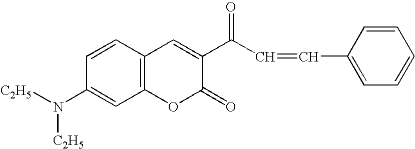 |
| D-61 | 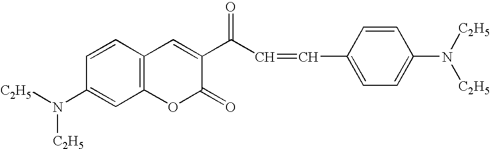 |

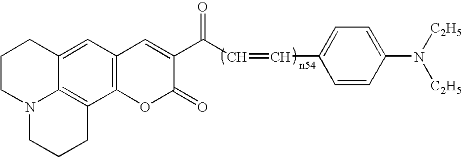

| | n54 |
|---|---|
| D-62 | 2 |
| D-63 | 3 |
| D-64 | 4 |

<pyran dye>

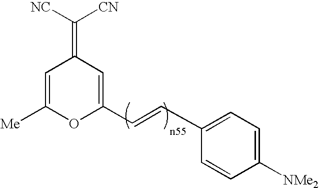

| | n55 |
|---|---|
| D-65 | 1 |
| D-66 | 2 |
| D-67 | 3 |
| D-68 | 4 |

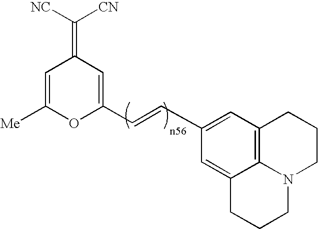

| | n56 |
|---|---|
| D-69 | 1 |
| D-70 | 2 |
| D-71 | 3 |

<xanthene dye>

| | |
|---|---|
| D-72 | 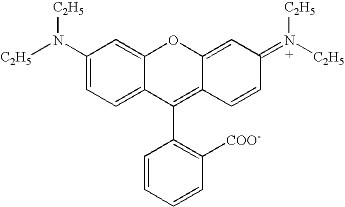 |
| D-73 | 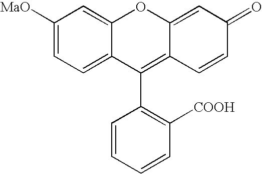 |
| D-74 | 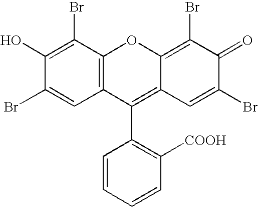 |

<thioxanthene dye>

| | |
|---|---|
| D-75 | 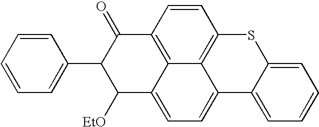 |

<phenothiazine dye>

| | |
|---|---|
| D-76 | 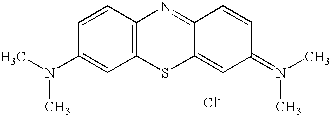 |

<phenoxazine dye>

| | |
|---|---|
| D-77 | 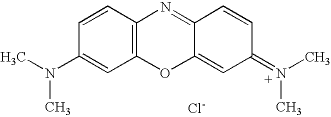 |

<phenazine dye>

| | |
|---|---|
| D-78 | 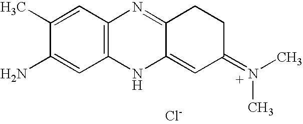 |

<phthalocyanine dye>

| | |
|---|---|
| D-79 | 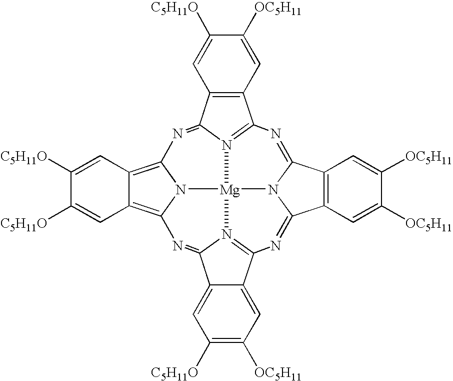 |

<azaporphiline dye>

| | |
|---|---|
| D-80 | 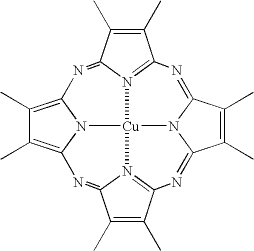 |
| D-81 | 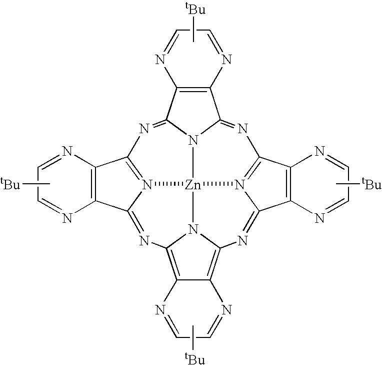 |

<porphiline dye>

| | |
|---|---|
| D-82 | 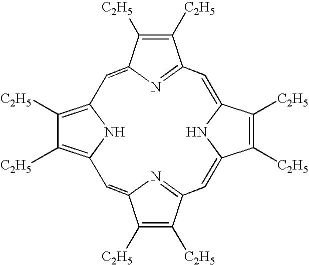 |
| D-83 | 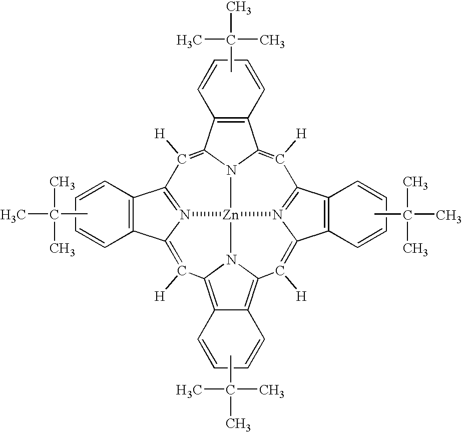 |

<condensed-ring aromatic dye>

| | |
|---|---|
| D-84 | 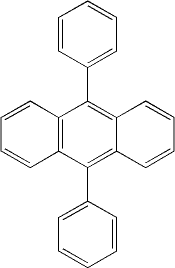 |
| D-85 | 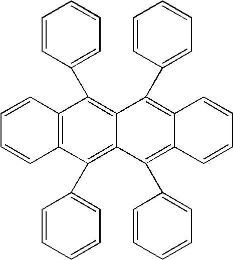 |
| D-86 | 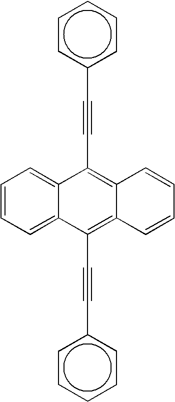 |
| D-87 | 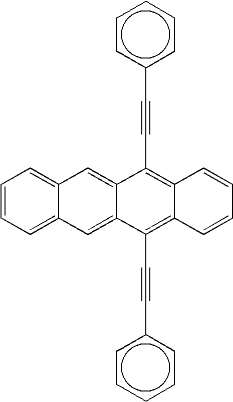 |

<perilene dye>

| | |
|---|---|
| D-88 | 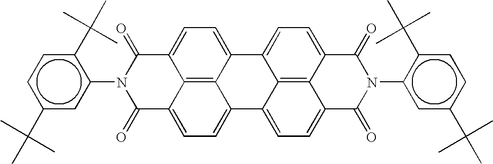 |

<azomethine dye>

| | |
|---|---|
| D-89 | 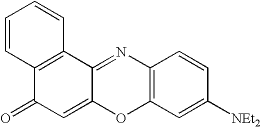 |

<anthraquinone dye>

| | |
|---|---|
| D-90 | 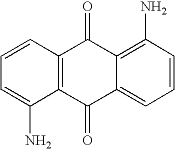 |

<metal complex dye>

| | |
|---|---|
| D-91 | 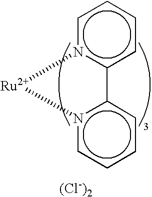 |
| D-92 | 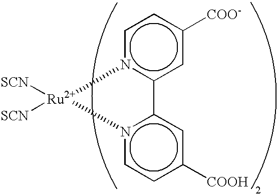 |
| D-93 | 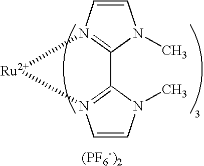 |
| D-94 | 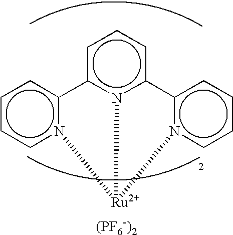 |
| D-95 | 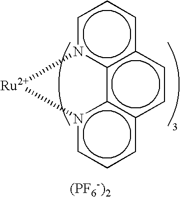 |
| D-96 | 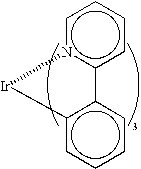 |
| D-97 | 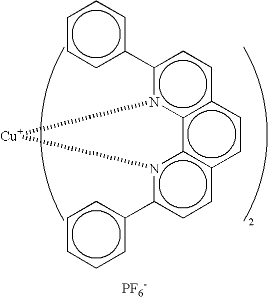 |
| D-98 | 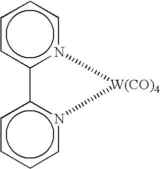 |
| D-99 | 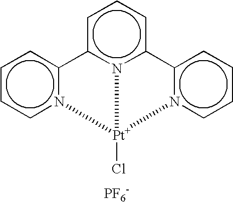 |
| D-100 | 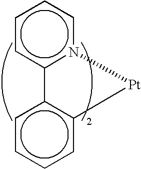 |

<metallocene dye>

| | |
|---|---|
| D-101 | 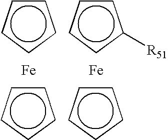 |

| | R₅₁ |
|---|---|
| D-102 | 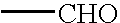 |
| D-103 | 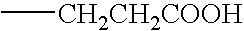 |
| D-104 | 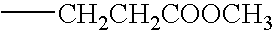 |
| D-105 | 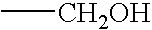 |
| D-106 | 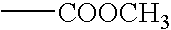 |
| D-107 | 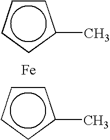 |
| D-108 | 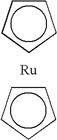 |
| D-109 | 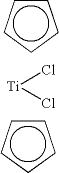 |

<continuation of cyanine dye>

| | |
|---|---|
| D-110 | 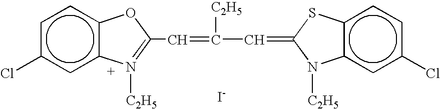 |
| D-111 | 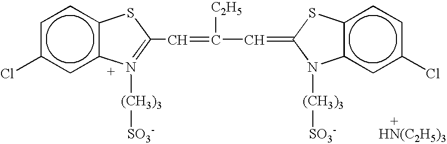 |
| D-112 | 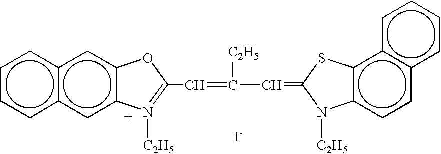 |
| D-113 | 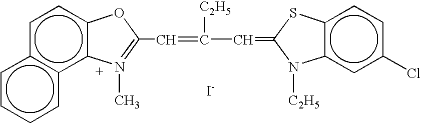 |
| D-114 | 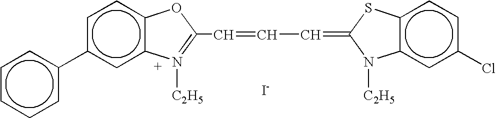 |

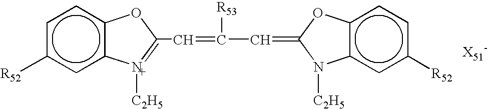

| | R₅₂ | R₅₃ | X₅₁ |
|---|---|---|---|
| D-115 | 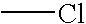 | 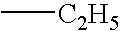 | 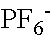 |
| D-116 | 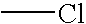 | 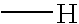 | 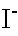 |
| D-117 | 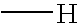 | 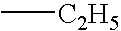 | — |
| D-118 | — | 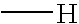 | — |
| D-119 | — | — | 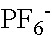 |
| D-120 | 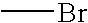 | — | 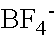 |
| D-121 | 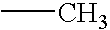 | — | 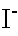 |
| D-122 | 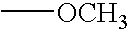 | 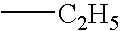 | 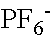 |

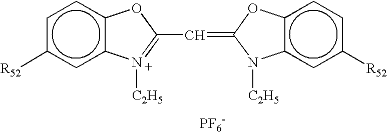

| | R₅₂ |
|---|---|
| D-123 | 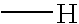 |
| D-124 | 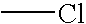 |
| D-125 | 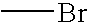 |
| D-126 | 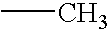 |
| D-127 | 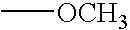 |
| D-128 | 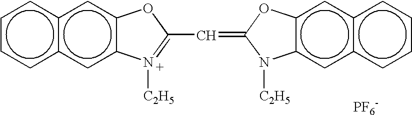 |
| D-129 | 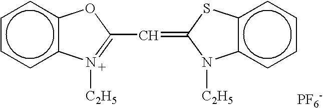 |

The sensitizing dye of the invention is commercially available or can be synthesized by a known method.

In the hologram recording method of the invention, the hologram recording is performed by an absorption of the light of the hologram recording wavelength, in case the sensitizing dye is not employed, by the photoreactive compound, or, in case the sensitizing dye is employed, by the sensitizing dye or by both the sensitizing dye and the phlotoreactive compound.

In such operation, since the hologram recording material has to be used with a large film thickness and a large proportion of the recording light has to be transmitted by the film, it is preferable, for achieving a high sensitivity, to reduce a molar absorption coefficient of the sensitizing dye and the photoreactive compound at the holographic exposure wavelength thereby maximizing the amounts of addition of the sensitizing dye and the photoreactive compound.

The sensitizing dye preferably has a molar absorption coefficient at the holographic exposure wavelength of 1 to 10,000, more preferably 1 to 5,000, further preferably 5 to 2,500 and most preferably 10 to 1,000.

Similarly, the photoreactive compound preferably has a molar absorption coefficient at the holographic exposure wavelength of 0 to 10,000, more preferably 0 to 5,000, further preferably 0 to 2,500 and most preferably 0 to 1,000.

Also in consideration of a diffraction efficiency, a sensitivity, and a recording density (level of multiplexing), the hologram recording material preferably has a transmittance at the wavelength of the recording light of 10-99%, more preferably 20-95%, further preferably 30-90% and most preferably 40-85%. It is therefore preferable to regulate the molar absorption coefficient at the recording wavelength and the molar concentration of the sensitizing dye and the photoreactive compound according to the thickness of the hologram recording material, so as to attain the aforementioned values.

Also the sensitizing dye more preferably has λₘₐₓ shorter than the hologram recording wavelength, and further preferably within a range from a wavelength same as the hologram recording wavelength to a wavelength shorter than the hologram recording wavelength by 100 nm.

Also the photoreactive compound more preferably has λₘₐₓ shorter than the hologram recording wavelength, and further preferably within a range from a wavelength same as the hologram recording wavelength to a wavelength shorter than the hologram recording wavelength by 200 nm.

Furthermore, the sensitizing dye preferably has a molar absorption coefficient at the recording wavelength equal to or less than ⅕ of the molar absorption coefficient at λₘₐₓ, more preferably equal to or less than 1/10.

Particularly in case the sensitizing dye is an organic dye such as a cyanine dye or a merocyanine dye, it is more preferably equal to or less than 1/20, further preferably equal to or less than 1/50 and most preferably equal to or less than 1/100.

In case the hologram recording is performed with a second harmonic wave of YAG laser with a wavelength of 532 Nm, the sensitizing dye is particularly preferably a trimethinecyanine dye having a benzoxazole ring, a Ru complex dye, or a ferrocene, and, in case of a GaN laser of a wavelength of 405-415 Nm, the sensitizing dye is particularly preferably a monomethinecyanine dye having a benzoxazole ring, a Ru complex dye or a ferrocene.

In the following, a polymerization initiator to be employed in the hologram recording material of the invention will be explained.

The polymerization initiator in the invention means a compound which generates a radical, an acid (Bronsted acid or Lewis acid) or a base (Bronsted base or Lewis base) by an energy transfer or an electron transfer from an excited state of the sensitizing dye or the photoreactive compound or by a direct excitation, thereby initiating a polymerization of the polymerizable compound.

The polymerization initiator of the invention can be a radical polymerization initiator capable of generating a radical thereby initiating a radical polymerization of the polymerizable compound, a cationic polymerization initiator capable of generating an acid only without generating a radical thereby initiating only a cationic polymerization of the polymerizable compound, a polymerization initiator capable of generating a radical and an acid thereby initiating a radical polymerization and a cationic polymerization, or an anionic polymerization initiator capable of generating a base thereby initiating an anionic polymerization.

At first there will be explained a radical polymerization initiator, a cationic polymerization initiator and an initiator capable of initiating both.

The polymerization initiator of the invention preferably includes following 12 systems. Such polymerization initiators may be employed, if necessary, as a mixture of two or more kinds in an arbitrary ratio.

1) ketone polymerization initiator;

2) organic peroxide polymerization initiator;

3) bisimidazole polymerization initiator;

4) trihalomethyl-substituted triazine polymerization initiator;

5) diazonium salt polymerization initiator;

6) diaryl iodonium salt polymerization initiator;

7) sulfonium salt polymerization initiator;

8) borate salt polymerization initiator;

9) diaryl iodonium salt-organic boron complex polymerization initiator;

10) sulfonium-organic boron complex polymerization initiator;

11) metal allene complex polymerization initiator; and

12) sulfonate ester polymerization initiator.

1) Ketone Polymerization Initiator

The ketone polymerization initiator can preferably be an aromatic ketone or an aromatic diketone.

Preferred examples include a benzophenone derivative (such as benzophenone, or Michler's ketone), a benzoin derivative (such as benzoin methyl ether, benzoin ethyl ether, α-methylbenzoin, α-allylbenzoin, or α-phenylbenzoin), an acetoin derivative (such as acetoin, pivaloin, 2-hydroxy-2-methylpropiophenone or 1-hydroxycycylohexyl phenyl ketone), an acyloin ether derivative (such as diethoxyacetophenone), an α-diketone derivative (diacetyl, benzyl, 4,4′-dimethoxybenzyl, benzyl dimethyl ketal, 2,3-bomanedion (camphor quinone), or 2,2,5,5-tetramethyltetrahydro-3,4-furanoic acid (imidazoletrione)), a xanthone derivative (such as xanthone), a thioxanthone derivative (such as thioxanthone or 2-chlorothioxanthone), and a ketocoumarin derivative.

Examples of commercial product include Irgacure 184, 651 and 907, manufactured by Ciba-Geigy Ltd. and represented by following formulas.

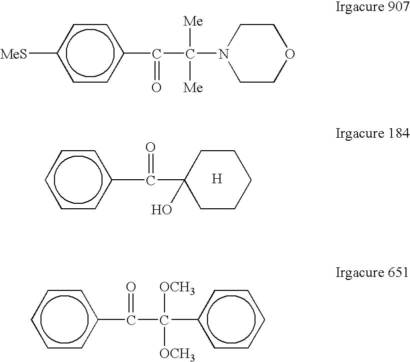

Preferred examples also include a quinone polymerization initiator (such as 9,10-anthraquinone, 1-chloroanthraquinone, 2-chloroanthraquinone, 2-methylanthraquinone, 2-ethylanthraquinone, 2-t-butylanthraquinone, octamethylanthraquinone, 1,4-naphthoquinone, 9,10-phenanthrenequinone, 1,2-benzanthraquinone, 2,3-benzanthraquinone, 2-methyl-1,4-naphthoquinone, 2,3-dichloronaphthoquinone, 1,4-dimethylanthraquinone, 2,3-dimethylanthraquinone, 2-phenylanthraquinone, 2,3-dimethylanthraquinone, anthraquinone-α-sulfonic acid sodium salt, 3-chloro-2-methylanthraquinone, retene quinone, 7,8,9,10-tetrahydronaphthacenequinone, or 1,2,3,4-tetrahydrobenz(a)anthracene-7,12-dione).

2) Organic Peroxide Polymerization Initiator

Preferred examples include benzoyl peroxide, di-t-butyl peroxide, and 3,3′,4,4′-tetra(t-butylperoxycarbonyl) benzophenone described in JP-A-59-189340 and JP-A-60-76503.

3) Bisimidazole Polymerization Initiator

A preferred bisimidazole polymerization initiator is a bis(2,4,5-triphenyl)imidazole derivative, such as bis(2,4,5-triphenyl)imidazole, 2-(o-chlorophenyl)-4,5-bis(m-methoxyphenyl)-imidazole dimer (CDM-HABI), 1,1′-biimidazole, 2,2′-bis(o-chlorophenyl)-4,4′,5,5′-tetraphenyl(o-Cl-HABI), 1H-imidazole, or 2,5-bis(o-chlorophenyl)-4-[3,4-dimethoxyphenyl] dimer (TCTM-HABI).

The bisimidazole polymerization initiator is preferably employed together with a hydrogen donating substance. The hydrogen donating substance can preferably be 2-mercaptobenzoxazole, 2-mercaptobenzothiazole, or 4-methyl-4H-1,2,4-triazole-3-thiol.

4) Trihalomethyl-Substituted Triazine Polymerization Initiator

The trihalomethyl-substituted triazine polymerization initiator can be represented by formula (11).

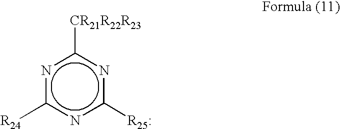

In the formula (11), R₂₁, R₂₂ and R₂₃ each independently represents a halogen atom, preferably a chlorine atom; and R₂₄ and R₂₅ each independently represents a hydrogen atom, —CR₂₁R₂₂R₂₃, or a substituent.

Preferred examples of the substituent include an alkyl group (preferably with C number of 1-20, such as methyl, ethyl, n-propyl, isopropyl, n-butyl, n-pentyl, benzyl, 3-sulfopropyl, 4-sulfobutyl, carboxymethyl, or 5-carboxypentyl), an alkenyl group (preferably with C number of 2-20, such as vinyl, allyl, 2-butenyl or 1,3-butadienyl), a cycloalkyl group (preferably with C number of 3-20, such as cyclopentyl or cyclohexyl), an aryl group (preferably with C number of 6-20, such as phenyl, 2-chlorophenyl, 4-methoxyphenyl, 3-methylphenyl or 1-naphthyl), a heterocyclic group (preferably with C number of 1-20, such as pyridyl, thienyl, furyl, thiazolyl, imidazolyl, pyrazolyl, pyrrolidino, piperidino or morpholino), an alkinyl group (preferably with C number of 2-20, such as ethinyl, 2-propinyl, 1,3-butadiinyl or 2-phenylethinyl), a halogen atom (such as F, Cl, Br or I), an amino group (preferably with C number of 0-20, such as amino, dimethylamino, diethylamino, dibutylamino or anilino), a cyano group, a nitro group, a hydroxyl group, a mercapto group, a carboxyl group, a sulfo group, a phosphonic acid group, an acyl group (preferably with C number of 1-20, such as acetyl, benzoyl, salicyloyl or pivaloyl), an alkoxy group (preferably with C number of 1-20, such as methoxy, butoxy or cyclohexyloxy), an aryloxy group (preferably with C number of 6-26, such as phenoxy or 1-naphthoxy), an alkylthio group (preferably with C number of 1-20, such as methylthio, or ethylthio), an arylthio group (preferably with C number of 6-20, such as phenylthio or 4-chlorophenylthio), an alkylsulfonyl group (preferably with C number of 1-20, such as methanesulfonyl or butanesulfonyl), an arylsulfonyl group (preferably with C number of 6-20, such as benzenesulfonyl or paratoluenesulfonyl), a sulfamoyl group (preferably with C number of 0-20, such as sulfamoyl, N-methylsulfamoyl or N-phenylsulfamoyl), a carbamoyl group (preferably with C number of 1-20, such as carbamoyl, N-methylcarbamoyl, N,N-dimethylcarbamoyl or N-phenylcarbamoyl), an acylamino group (preferably with C number of 1-20, such as acetylamino or benzoylamino), an imino group (preferably with C number of 2-20, such as phthalimino), an acyloxy group (preferably with C number of 1-20, such as acetyloxy, or benzoyloxy), an alkoxycarbonyl group (preferably with C number of 2-20, such as methoxycarbonyl or phenoxycarbonyl), and a carbamoylamino group (preferably with C number of 1-20, such as carbamoylamino, N-methylcarbamoylamino or N-phenylcarbamoylamino), and more preferably an alkyl group, an aryl group, a heterocyclic group, a halogen atom, a cyano group, a carboxyl group, a sulfo group, an alkoxy group, a sulfamoyl group, a carbamoyl group and an alkoxycarbonyl group.

R₂₄ preferably represents —CR₂₁R₂₂R₂₃, more preferably a —OCl₃ group; R₂₅ preferably represents —CR₂₁R₂₂R₂₃, an alkyl group, an alkenyl group or an aryl group.

Specific examples of the trihalomethyl-substituted triazine polymerization initiator include 2-methyl-4,6-bis(trichloromethyl)-1,3,5-triazine, 2,4,6-tris(trichloromethyl)-1,3,5-triazine, 2-phenyl-4,6-bis(trichloromethyl)-1,3,5-triazine, 2-(4′-methoxyphenyl)-4,6-bis(trichloromethyl)-1,3,5-triazine, 2-(4′-trifluoromethylphenyl)-4,6-bis(trichloromethyl)-1,3,5-triazine, 2,4-bis(trichloromethyl)-6-(p-methoxyphenylvinyl)-1,3,5 -triazine, and 2-(4′-methoxy-1′-naphthyl)-4,6-bis(trichloromethyl)-1,3,5-triazine. Preferred examples also include compounds described in BP No. 1388492 and JP-A-53-133428.

5) Diazonium Salt Polymerization Initiator

The diazonium salt polymerization initiator is preferably represented by formula (12).

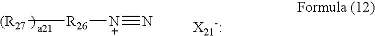

R₂₆ represents an aryl group or a heterocyclic group, preferably an aryl group and more preferably a phenyl group.

R₂₇ represents a substituent (of which preferred examples are same as those cited for R₂₄); a21 represents an integer from 0-5, preferably 0-2; and in case a21 represents an integer of 2 or larger, plural R₂₇s may be mutually same or different or may be mutually bonded to form a ring.

X₂₁⁻ is an anion capable of forming an acid HX₂₁⁻ with a pKa value (at 25° C. in water) of 4 or less, preferably 3 or less and more preferably 2 or less, and preferred examples include chloride, bromide, iodide, tetrafluoroborate, hexafluorophosphate, hexafluoroarsenate, hexafluoroantimonate, perchlorate, trifluoromethanesulfonate, 9,10-dimethoxyanthracene-2-sulfonate, methanesulfonate, benzenesulfonate, 4-trifluoromethylbenzenesulfonate, tosylate and tetra(pentafluorophenyl)borate.

Specific examples of the diazonium salt polymerization initiator include the X₂₁⁻ salts of benzene diazonium, 4-methoxydiazonium and 4-methyldiazonium.

6) Diaryl Iodonium Salt Polymerization Initiator

The diaryl iodonium salt polymerization initiator is preferably represented by formula (13).

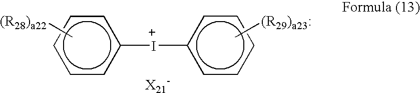

In the formula (13), X₂₁⁻ has the same meaning as in the formula (12). R₂₈ and R₂₉ each independently represents a substituent (of which preferred examples are same as those for R₂₄), preferably an alkyl group, an alkoxy group, a halogen atom, a cyano group or a nitro group.

a22 and a23 each independently represents an integer of 0-5, preferably 0-1; in case a21 represents 2 or larger, plural R₂₈s or R₂₉s may be mutually same or different or may be mutually bonded to form a ring.

Specific examples of the diaryl iodonium salt polymerization initiator include chloride, bromide, iodide, tetrafluoroborate, hexafluorophosphate, hexafluoroarsenate, hexafluoroantimonate, perchlorate, trifluoromethanesulfonate, 9,10-dimethoxyanthracene-2-sulfonate, methanesulfonate, benzenesulfonate, 4-trifluoromethylbenzenesulfonate, tosylate, tetra(pentafluorophenyl)borate, perfluorobutanesulfonate and pentafluorobenzenesulfonate of diphenyl iodonium, 4,4′-dichlorodiphenyl iodonium, 4,4′-dimethoxydiphenyl iodonium, 4,4′-dimethyldiphenyl iodonium, 4,4′-di-t-butyldiphenyl iodonium, 4,4′-di-t-amyldiphenyl iodonium, 3,3′-dinitrodiphenyl iodonium, phenyl(p-methoxyphenyl) iodonium, phenyl(p-octyloxyphenyl) iodonium and bis(p-cyanophenyl) iodonium.

There can also be employed compounds described in Macromolecules, 10, p. 1307(1977), and diaryl iodonium salts described in JP-A-58-29803 and JP-A-1-287105 and in Japanese Patent Application No. 3-5569.

7) Sulfonium Salt Polymerization Initiator

The sulfonium salt polymerization initiator is preferably represented by formula (14).

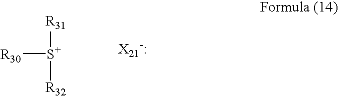

In the formula (14), X₂₁⁻ has the same meaning as in the formula (12). R₃₀, R₃₁ and R₃₂ each independently represents an alkyl group, an aryl group or a heterocyclic group (of which preferred examples are same as those for R₂₄), preferably an alkyl group, a phenacyl group or an aryl group.

Specific examples of the sulfonium salt polymerization initiator include chloride, bromide, tetrafluoroborate, hexafluorophosphate, hexafluoroarsenate, hexafluoroantimonate, perchlorate, trifluoromethanesulfonate, 9,10-dimethoxyanthracene-2-sulfonate, methanesulfonate, benzenesulfonate, 4-trifluoromethylbenzenesulfonate, tosylate, tetra(pentafluorophenyl)borate, perfluorobutanesulfonate and pentafluorobenzenesulfonate of a sulfonium salt such as triphenyl sulfonium, diphenylphenacyl sulfonium, dimethylphenacyl sulfonium, benzyl-4-hydroxyphenylmethyl sulfonium, 4-t-butyltriphenyl sulfonium, tris(4-methylphenyl)sulfonium, tris(4-methoxyphenyl)sulfonium, 4-phenylthiotriphenyl sulfonium, and bis-1-(4-(diphenylsulfonium)phenyl)sulfide.

8) Borate Salt Polymerization Initiator

The borate salt polymerization initiator is preferably represented by formula (15)

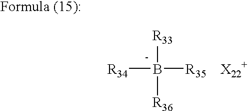

In the formula (15), R₃₃, R₃₄, R₃₅ and R₃₆ each independently represents an alkyl group, an alkenyl group, an alkinyl group, a cycloalkyl group or an aryl group (of which preferable examples are same as those for R₂₄), preferably an alkyl group or an aryl group, however all of R₃₃, R₃₄, R₃₅ and R₃₆ do not become aryl groups at the same time; and X₂₂⁺ represents a cation.

More preferably R₃₃, R₃₄ and R₃₅ are aryl groups and R₃₆ is an alkyl group, and most preferably R₃₃, R₃₄ and R₃₅ are phenyl groups and R₃₆ is an n-butyl group.

Specific examples of the borate salt polymerization initiator include tetrabutyl ammonium n-butyltriphenyl borate, and tetramethyl ammonium sec-butyltriphenyl borate.

9) Diaryl Iodonium-Organic Boron Complex Polymerization Initiator

The diaryl iodonium-organic boron complex polymerization initiator is preferably represented by formula (16).

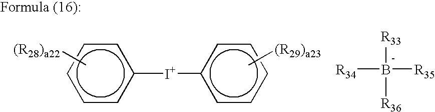

In the formula (16), R₂₈, R₂₉, a22 and a23 have the same meanings as in the formula (13), and R₃₃, R₃₄, R₃₅ and R₃₆ have the same meanings as in the formula (15).

Specific examples of the diaryl iodonium-organic boron complex polymerization initiator include I-1 to I-3 shown in the following.

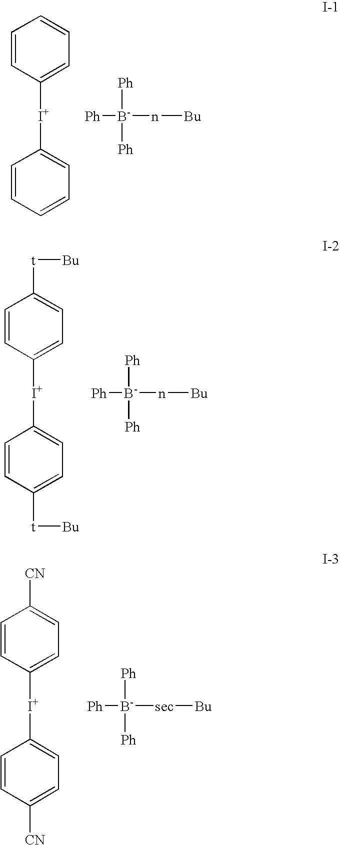

Preferred examples also include an iodonium-organic boron complex such as diphenyl iodonium (n-butyl)triphenyl borate described in JP-A-3-704.

10) Sulfonium-Organic Boron Complex Polymerization Initiator

The sulfonium-organic boron complex polymerization initiator is preferably represented by formula (17). Formula (17):

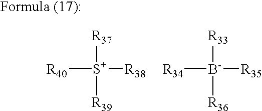

In the formula (17), R₃₃, R₃₄, R₃₅ and R₃₆ have the same meanings as in the formula (15). R₃₇, R₃₈ and R₃₉ each independently represents an alkyl group, an aryl group, an alkenyl group, an alkinyl group, a cycloalkyl group, an alkoxy group, an aryloxy group, an alkylthio group, an arylthio group or an amino group (preferred example of the foregoing being same as those for R₂₄), more preferably an alkyl group, a phenacyl group, an aryl group or an alkenyl group. R₃₇, R₃₈ and R₃₉ may be mutually bonded to form a ring. R₄₀ represents an oxygen atom or an isolated electron pair.

Specific examples of the sulfonium-organic boron complex polymerization initiator include I-4 to I-10 shown in the following.

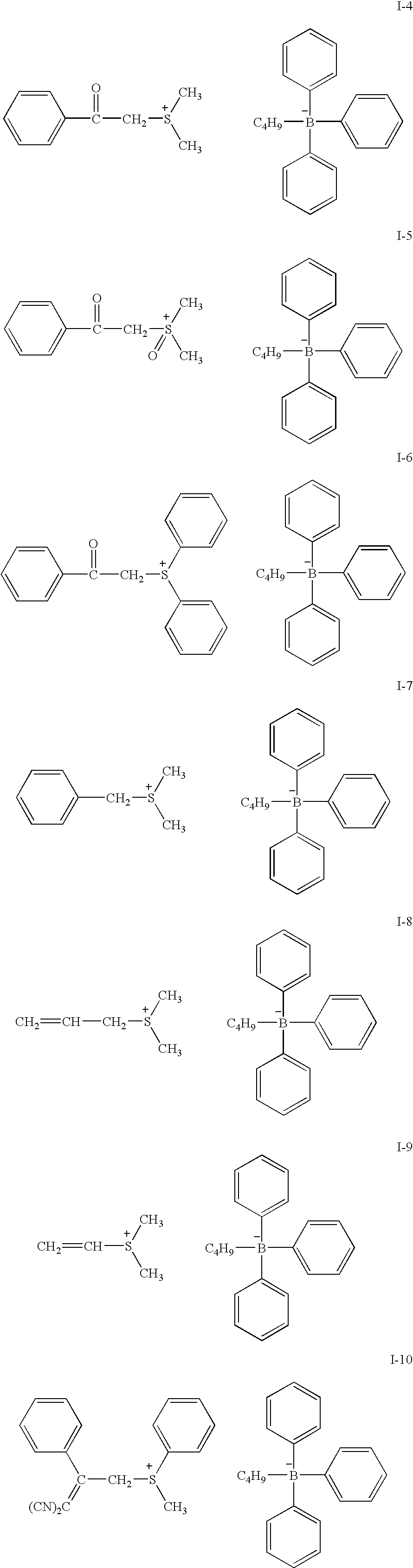

Preferred examples also include a sulfonium-organic boron complex described in JP-A-5-255347 and JP-A-5-213861.

11) Metal Allene Complex Polymerization Initiator

In the metal allene complex polymerization initiator, the metal is preferably iron or titanium.

Specific preferred examples include an iron allene complex described in JP-A-1-54440, EP Nos. 109851 and 126712, and J. Imag. Sci., vol. 30, p. 174(1986), an iron allene-organic boron complex described in Organometallics, vol. 8, 2737(1989), an iron allene complex salt described in Prog. Polym. Sci., vol. 21, p.7-8 (1996), and a titanocene described in JP-A-61-151197.

12) Sulfonate Ester Polymerization Initiator

The sulfonate ester polymerization initiator can preferably be a sulfonate ester, a sulfonate nitrobenzyl ester or an imide sulfonate.

Specific examples of preferred sulfonate ester include benzoin tosylate and pyrogallol trimesylate; those of preferred sulfonate nitrobenzyl ester include o-nitrobenzyl tosylate, 2,6-dinitrobenzyl tosylate, 2′,6′-dinitrobenzyl-4-nitrobenzene sulfonate, p-nitrobenzyl-9,10-diethoxyanthracene-2-sulfonate and 2-nitrobenzyltrifluoromethyl sulfonate; and those of imide sulfonate include N-tosylphthalimide, 9-fluorenylidene aminotosylate and α-cyanobenzylidene tosylamine.

13) Other Polymerization Initiator

Other polymerization initiators than those of 1)-12) mentioned above include an organic azide compound such as 4,4′-diazidecalcon, an aromatic carboxylic acid such as N-phenylglycine, a polyhalogen compound (such as CI₄, CFH₃, or CBrI₃), a pyridinium salt such as 1-benzyl-2-cyanopyridinium hexafluoroantimonate, phenylisooxazolone, a silanol-aluminum complex and an aluminate complex described in JP-A-3-209477.

The radical or cationic polymerization initiator in the invention can be classified into:

a) polymerization initiator which can activate a radical polymerization;

b) polymerization initiator which can activate only a cationic polymerization; and

c) polymerization initiator which can simultaneously activate a radical polymerization and a cationic polymerization.

a) A polymerization initiator which can activate a radical polymerization means a polymerization initiator which generates a radical by an energy transfer or an electron transfer (an electron donation to the sensitizing dye or an electron reception therefrom) from an excited state of the sensitizing dye or the photoreactive compound or by a direct excitation, thereby initiating a radical polymerization of the polymerizable compound.

Among the foregoing, following polymerization initiator systems are capable of activating a radical polymerization:

1) ketone polymerization initiator;

2) organic peroxide polymerization initiator;

3) bisimidazole polymerization initiator;

4) trihalomethyl-substituted triazine polymerization initiator;

5) diazonium salt polymerization initiator;

6) diaryl iodonium salt polymerization initiator;

7) sulfonium salt polymerization initiator;

8) borate salt polymerization initiator;

9) diaryl iodonium salt-organic boron complex polymerization initiator;

10) sulfonium-organic boron complex polymerization initiator; and

11) metal allene complex polymerization initiator.

The polymerization initiator capable of activating a radical polymerization is more preferably:

1) ketone polymerization initiator;

3) bisimidazole polymerization initiator;

4) trihalomethyl-substituted triazine polymerization initiator;

6) diaryl iodonium salt polymerization initiator; or

7) sulfonium salt polymerization initiator, and further preferably:

3) bisimidazole polymerization initiator;

6) diaryl iodonium salt polymerization initiator; or

7) sulfonium salt polymerization initiator.

A polymerization initiator which can activate only a cationic polymerization means a polymerization initiator which generates an acid (Bronsted acid or Lewis acid) by an energy transfer or an electron transfer from an excited state of the sensitizing dye or the photoreactive compound or by a direct excitation, without generating a radical, thereby initiating a cationic polymerization of the polymerizable compound by such acid.

Among the foregoing systems, following polymerization initiator system is capable of activating only a radical polymerization:

12) sulfonate ester polymerization initiator.

As the cationic polymerization initiator, there can also be employed those described for example in “UV Curing: Science and Technology”, p. 23-76, S. Peter Pappas, A Technology Marketing Publication, and Comments Inorg. Chem., B. Klingert, M. Riediker and A. Roloff, vol. 7, No. 3, p. 109-138(1988).

A polymerization initiator which can simultaneously activate a radical polymerization and a cationic polymerization means a polymerization initiator which generates a radical and an acid (Bronsted acid or Lewis acid) by an energy transfer or an electron transfer from an excited state of the sensitizing dye or the photoreactive compound or by a direct excitation, thereby initiating a radical polymerization of the polymerizable compound by the generated radical and initiating a cationic polymerization of the polymerizable compound by the generated acid.

Among the foregoing, following polymerization initiator systems are capable of simultaneously activating a radical polymerization and a cationic polymerization:

4) trihalomethyl-substituted triazine polymerization initiator;

5) diazonium salt polymerization initiator;

6) diaryl iodonium salt polymerization initiator;

7) sulfonium salt polymerization initiator; and

11) metal allene complex polymerization initiator.

The polymerization initiator system capable of simultaneously activating a radical polymerization and a cationic polymerization is preferably:

6) diaryl iodonium salt polymerization initiator; or 7) sulfonium salt polymerization initiator.

In the following there will be explained an anionic polymerization initiator in the invention. The anionic polymerization initiator in the invention is preferably a base generating agent generating a base (Bronsted base or Lewis base) thereby initiating an anionic polymerization.

The base generating agent means a compound which generates a base (Bronsted base or Lewis base) by an energy transfer or an electron transfer from an excited state of the sensitizing dye or the photoreactive compound or by a direct excitation. The base generating agent is preferably stable in a dark place. The base generating agent in the present invention is preferably a compound capable of generating a base by an electron transfer from an excited state of the sensitizing dye or the photoreactive compound.

The base generating agent in the present invention preferably generates a Bronsted base by a light, more preferably generates an organic base, and particularly preferably generates an amine as the organic base.

The anionic polymerization initiator of the invention, namely the base generating agent, is preferably represented by the formulas (1-1)-(1-4). The base generating agent may be employed, if necessary, as a mixture of two or more kinds of an arbitrary mixing ratio.

In the formula (1-1) or (1-2), R₁ and R₂ each independently represents a hydrogen atom, an alkyl group (preferably with 1-20 carbon atoms (hereinafter represented as C number), such as methyl, ethyl, n-propyl, isopropyl, n-butyl, n-pentyl, n-octadecyl, benzyl, 3-sulfopropyl, 4-sulfobutyl, carboxymethyl or 5-carboxypentyl), an alkenyl group (preferably with C number of 2-20, such as vinyl, allyl, 2-butenyl or 1,3-butadienyl), a cycloalkyl group (preferably with C number of 3-20, such as cyclopentyl or cyclohexyl), an aryl group (preferably with C number of 6-20, such as phenyl, 2-chlorophenyl, 4-methoxyphenyl, 3-methylphenyl, 1-naphthyl or 2-naphthyl), or a heterocyclic group (preferably with C number of 1-20, such as pyridyl, thienyl, furyl, thiazolyl, imidazolyl, pyrazolyl, pyrrolidino, piperidino or morpholino), more preferably a hydrogen atom, an alkyl group, or a cycloalkyl group, and further preferably a hydrogen atom, a methyl group, an ethyl group, a cyclohexyl group or a cyclopentyl group.

R₁ and R₂ may be mutually bonded to form a ring, and a formed heterocycle is preferably a piperidine ring, a pyrrolidine ring, a piperazine ring, a morpholine ring, a pyridine ring, a quinoline ring, or an imidazole ring, more preferably a piperidine ring, a pyrrolidine ring, or an imidazole ring, and most preferably a piperidine ring.

A more preferred combination of R₁ and R₂ includes a case where R₁ is a cyclohexyl group that may be substituted and R₂ is a hydrogen atom; a case where R₁ is an alkyl group that may be substituted and R₂ is a hydrogen atom; and a case where R₁ and R₂ are bonded to form a piperidine ring or an imidazole ring.

In the formula (1-1) or (1-2), n1 represents 0 or 1, preferably 1.

In the formula (1-1), R₃ each independently represents a substituent, and preferred examples of the substituent include an alkyl group (preferably with C number of 1-20, such as methyl, ethyl, n-propyl, isopropyl, n-butyl, n-pentyl, benzyl, 3-sulfopropyl, 4-sulfobutyl, carboxymethyl, or 5-carboxypentyl), an alkenyl group (preferably with C number of 2-20, such as vinyl, allyl, 2-butenyl or 1,3-butadienyl), a cycloalkyl group (preferably with C number of 3-20, such as cyclopentyl or cyclohexyl), an aryl group (preferably with C number of 6-20, such as phenyl, 2-chlorophenyl, 4-methoxyphenyl, 3-methylphenyl or 1-naphthyl), a heterocyclic group (preferably with C number of 1-20, such as pyridyl, thienyl, furyl, thiazolyl, imidazolyl, pyrazolyl, pyrrolidino, piperidino or morpholino), an alkinyl group (preferably with C number of 2-20, such as ethinyl, 2-propinyl, 1,3-butadiinyl or 2-phenylethinyl), a halogen atom (such as F, Cl, Br or I), an amino group (preferably with C number of 0-20, such as amino, dimethylamino, diethylamino, dibutylamino or anilino), a cyano group, a nitro group, a hydroxyl group, a mercapto group, a carboxyl group, a sulfo group, a phosphonic acid group, an acyl group (preferably with C number of 1-20, such as acetyl, benzoyl, salicyloyl or pivaloyl), an alkoxy group (preferably with C number of 1-20, such as methoxy, butoxy or cyclohexyloxy), an aryloxy group (preferably with C number of 6-26, such as phenoxy or 1-naphthoxy), an alkylthio group (preferably with C number of 1-20, such as methylthio, or ethylthio), an arylthio group (preferably with C number of 6-20, such as phenylthio or 4-chlorophenylthio), an alkylsulfonyl group (preferably with C number of 1-20, such as methanesulfonyl or butanesulfonyl), an arylsulfonyl group (preferably with C number of 6-20, such as benzenesulfonyl or paratoluenesulfonyl), a sulfamoyl group (preferably with C number of 0-20, such as sulfamoyl, N-methylsulfamoyl or N-phenylsulfamoyl), a carbamoyl group (preferably with C number of 1-20, such as carbamoyl, N-methylcarbamoyl, N,N-dimethylcarbamoyl or N-phenylcarbamoyl), an acylamino group (preferably with C number of 1-20, such as acetylamino or benzoylamino), an imino group (preferably with C number of 2-20, such as phthalimino), an acyloxy group (preferably with C number of 1-20, such as acetyloxy, or benzoyloxy), an alkoxycarbonyl group (preferably with C number of 2-20, such as methoxycarbonyl or phenoxycarbonyl), and a carbamoylamino group (preferably with C number of 1-20, such as carbamoylamino, N-methylcarbamoylamino or N-phenylcarbamoylamino), and more preferably an alkyl group, an aryl group, a heterocyclic group, a halogen atom, an amino group, a cyano group, a nitro group, a carboxyl group, a sulfo group, an alkoxy group, an alkylthio group, an arylsulfonyl group, a sulfamoyl group, a carbamoyl group and an alkoxycarbonyl group.

In the formula (1-1), R₃ is preferably a nitro group or an alkoxy group, more preferably a nitro group or a methoxy group, and most preferably a nitro group.

In the formula (1-1), n2 represents an integer of 0-5, preferably 0-3, and more preferably 1 or 2. In case n2 is 2 or larger, the plural R₃s may be mutually same or different, or may be bonded to form a ring, and a ring to be formed is preferably a benzene ring or a naphthalene ring.

In case R₃ represents a nitro group in the formula (1-1), it is preferably substituted in 2-position or 2,6-positions, and, in case R₃ represents an alkoxy group, it is preferably substituted in 3,5-positions.

In the formula (1-1), R and R₅ each independently represents a hydrogen atom or a substituent (preferred examples being same as those for R₃), preferably represents a hydrogen atom, an alkyl group, or an aryl group, more preferably a hydrogen atom, a methyl group or a 2-nitrophenyl group.

A more preferred combination of R₄ and R₅ includes a case where R₄ and R₅ are both hydrogen atoms, a case where R₄ is a methyl group and R₅ is a hydrogen atom, a case where R₄ and R₅ are both methyl groups, and a case where R₄ is a 2-nitrophenyl group and R₅ is a hydrogen atom, and more preferably a case where R₄ and R₅ are both hydrogen atoms.

In the formula (1-2), R₆ and R₇ each independently represents a substituent (preferred examples being same as those for R₃), preferably represents an alkoxy group, an alkylthio group, a nitro group or an alkyl group, and more preferably a methoxy group.

In the formula (1-2), n3 and n4 each independently represents an integer of 0-5, preferably 0-2. In case n3, n4 2 or larger, the plural R₆s or R₇s may be mutually same or different, or may be bonded to form a ring, and a ring to be formed is preferably a benzene ring or a naphthalene ring.

In the formula (1-2), R₆ is more preferably alkoxy groups substituted in 3, 5-positions and further preferably methoxy groups substituted in 3, 5-positions.

In the formula (1-2), R₉ represents a hydrogen atom or a substituent (preferred examples being same as those for R₃), preferably a hydrogen atom or an aryl group, and more preferably a hydrogen atom.

In the formula (1-3), R₉ represents a substituent (preferred examples being same as those for R₃), preferably an alkyl group, an aryl group, a benzyl group, or an amino group, and more preferably an alkyl group that may be substituted, a t-butyl group, a phenyl group, a benzyl group, an anilino group that may be substituted, or a cyclohexylamino group.

The compound represented by the formula (1-3) may be a compound connected to a polymer chain at R₉.

In the formula (1-3), R₁₀ and R₁₁ each independently represents a hydrogen atom or a substituent (preferred examples being same as those for R₃), preferably an alkyl group or an aryl group, and more preferably a methyl group, a phenyl group or a 2-naphthyl group.

R₁₀ and R₁₁ may be mutually bonded to form a ring, and a preferred ring to be formed is for example a fluorene ring.

In the formula (1-4), R₁₂ represents an aryl group or a heterocyclic group, and more preferably an aryl group or a heterocyclic group shown in the following.

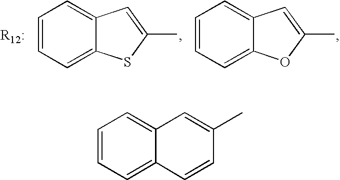

In the formula (1-4), R₁₃, R₁₄ and R₁₅ each independently represents a hydrogen atom, an alkyl group, an alkenyl group, a cycloalkyl group, an aryl group or a heterocyclic group (preferred examples of the foregoing being same as those for R₁ and R₂), preferably represents an alkyl group, and more preferably a butyl group. R₁₃, R₁₄ and R₁₅ may be mutually bonded to form a ring, and a heterocycle to be formed is preferably a piperidine ring, a pyrrolidine ring, a piperazine ring, a morpholine ring, a pyridine ring, a quinoline ring, or an imidazole ring, and more preferably a piperidine ring, a pyrrolidine ring, or an imidazole ring.

In the formula (1-4), R₁₆, R₁₇, R₁₈ and R₁₉ each independently represents an alkyl group or an aryl group, and it is preferable that R₁₆, R₁₇ and R₁₈ are phenyl groups and Rig is an n-butyl group or a phenyl group.

The base generating agent in the invention is preferably represented by the formula (1-1) or (1-3), more preferably by the formula (1-1).

In the following, preferred specific examples of the base generating agent in the invention will be shown, but the present invention is not limited to such examples.

| | |
|---|---|
| PB-1 | 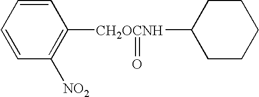 |
| PB-2 | 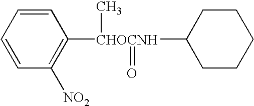 |
| PB-3 | 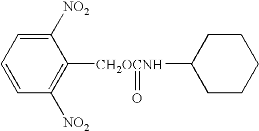 |
| PB-4 | 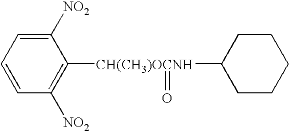 |
| PB-5 | 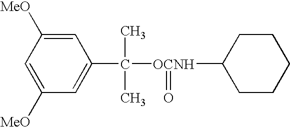 |
| PB-6 | 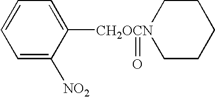 |
| PB-7 | 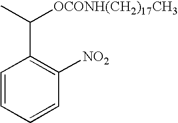 |
| PB-8 | 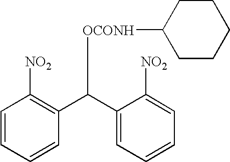 |
| PB-9 | 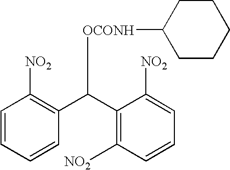 |
| PB-10 | 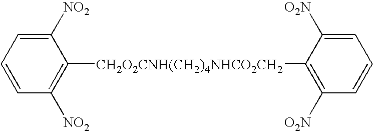 |
| PB-11 | 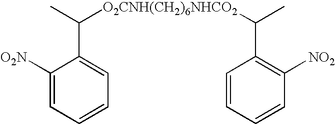 |
| PB-12 | 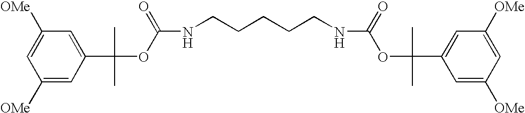 |
| PB-13 | 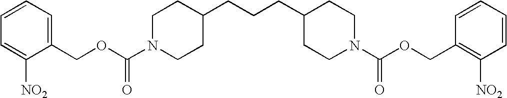 |
| PB-14 | 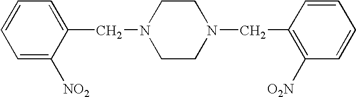 |
| PB-15 | 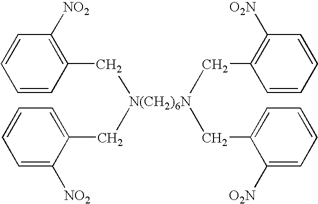 |

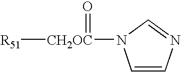

| | R₅₁ |
|---|---|
| PB-16 | 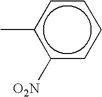 |
| PB-17 | 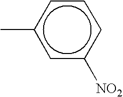 |
| PB-18 | 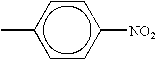 |
| PB-19 | 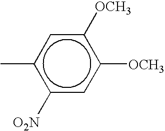 |

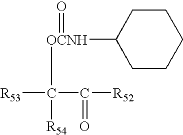

| | R₅₂ | R₅₃ | R₅₄ |
|---|---|---|---|
| PB-20 | 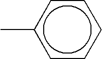 | 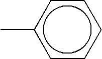 | 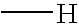 |
| PB-21 | 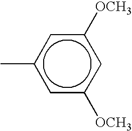 | 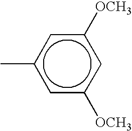 | — |
| PB-22 | 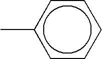 | — | — |
| PB-23 | 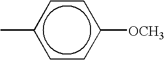 | — | — |
| PB-24 | 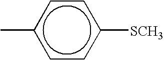 | — | — |
| PB-25 | 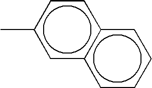 | — | — |
| PB-26 | 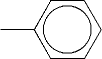 | — | 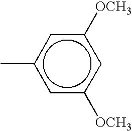 |

| | |
|---|---|
| PB-27 | 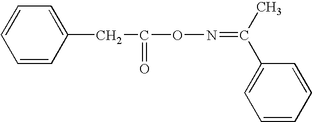 |
| PB-28 | 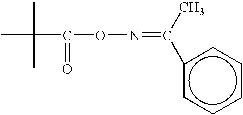 |
| PB-29 | 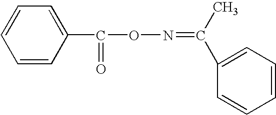 |
| PB-30 | 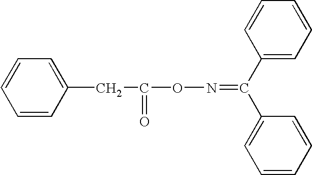 |
| PB-31 | 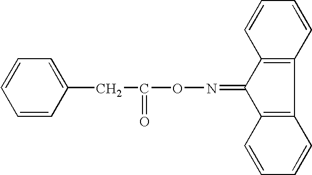 |
| PB-32 | 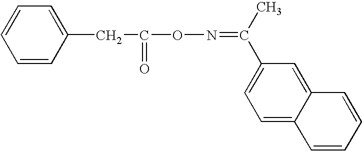 |
| PB-33 | 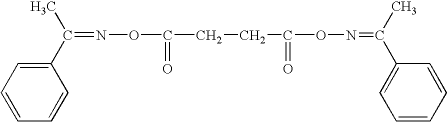 |
| PB-34 | 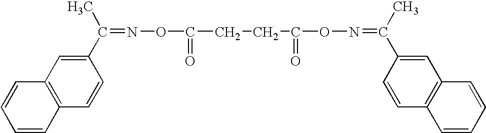 |
| PB-35 | 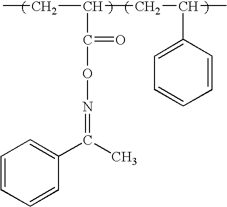 |
| PB-36 | 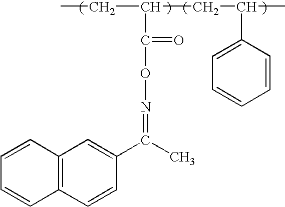 |
| PB-37 | 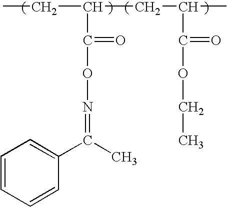 |
| PB-38 | 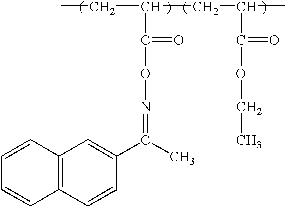 |
| PB-39 | 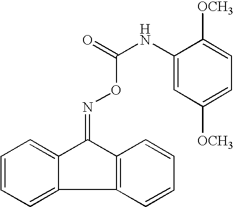 |

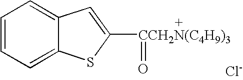

| | 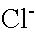 |
|---|---|
| PB-40 | 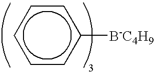 |
| PB-41 | 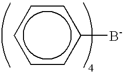 |
| PB-42 | 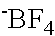 |

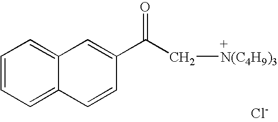

| | 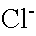 |
|---|---|
| PB-43 | 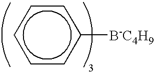 |
| PB-44 | 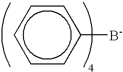 |

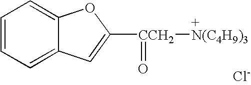

| | 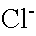 |
|---|---|
| PB-45 | 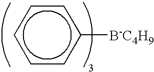 |
| PB-46 | 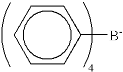 |

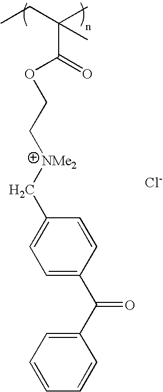

| | 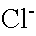 |
|---|---|
| PB-47 | 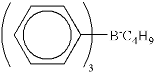 |
| PB-48 | 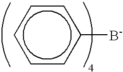 |

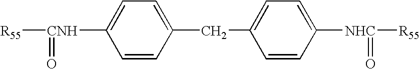

| | R₅₅ |
|---|---|
| PB-49 | 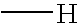 |
| PB-50 | 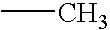 |
| PB-51 | 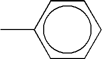 |
| PB-52 | 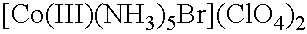 |
| PB-53 | 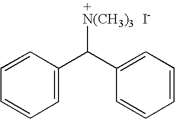 |
| PB-54 | 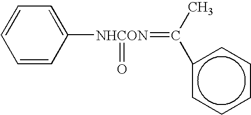 |
| PB-55 | 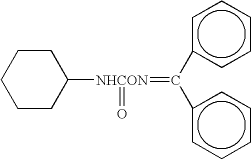 |

In the hologram recording material of the invention, a solvent is advantageously employed. The solvent is usually employed for the purposes of improving a film forming property of the composition, a uniformity of film thickness and a stability in storage. The binder preferably has a satisfactory mutual solubility with the liquid crystalline compound, the polymerization initiator, the photoreactive compound and the sensitizing dye.

The binder is preferably a thermoplastic polymer soluble in a solvent, and may be employed singly or in a combination.

The binder may have a reactive site and may be crosslinked or cured by a reaction with a crosslinking agent, a polymerizable monomer or an oligomer. A reactive site in such case can preferably be a radical reactive site for example an ethylenic unsaturated group such as an acryl group or a methacryl group, a cationic reactive site for example an oxilane compound, an oxetane compound or a vinyl ether group, or a condensation polymerization reactive site for example a carboxylic group, an alcohol or an amine.

Examples of a preferred binder to be employed in the invention include an acrylate, an α-alkyl acrylate ester, an acidic polymer and an interpolymer (such as polymethyl methacrylate, polyethyl methacrylate, a copolymer of methyl methacrylate and another alkyl (meth)acrylate ester), a polyvinyl ester (such as polyvinyl acetate, polyvinyl acetate/acrylate, polyvinyl acetate/methacrylate and hydrolyzed polyvinyl acetate), an ethylene/vinyl acetate copolymer, a saturated or unsaturated polyurethane, a butadiene or isoprene polymer/copolymer, a high-molecular polyoxyethylene of a polyglycol having a weight-averaged molecular weight of about 4,000-1,000,000, an epoxide (such as an epoxide having an acrylate group or a methacrylate group), a polyamide (such as N-methoxymethyl polyhexamethylene-azipamide), a cellulose ester (such as cellulose acetate, cellulose acetate succinate or cellulose acetate butyrate), a cellulose ether (such as methylcellulose, ethylcellulose, or ethylbenzylcellulose), polycarbonate, polyvinylacetal (such as polyvinyl butyral or polyvinyl formal), polyvinyl alcohol, polyvinylpyrrolidone, and an acid-containing polymer/copolymer functioning as a binder as described in U.S. Pat. Nos. 3,458,311 and 4,273,857.

There are also included a polystyrene polymer, or a copolymer thereof with acrylonitrile, maleic anhydride, acrylic acid, methacrylic acid or an ester thereof, a vinylidene chloride copolymer (such as a vinylidene chloride/acrylonitrile copolymer, a vinylidene chloride/methacrylate copolymer, or a vinylidene chloride/vinyl acetate copolymer), polyvinyl chloride and a copolymer thereof (such as polyvinyl chloride/acetate, or a vinyl chloride/acrylonitrile copolymer), a polyvinyl benzal synthetic rubber (such as a butadiene/acrylonitrile copolymer), an acrylonitrile/butadiene/styrene copolymer, a methacrylate/acrylonitrile/butadiene/styrene copolymer, a 2-chlorobutadiene-1,3-polymer, chlorinated rubber, a styrene/butadiene/styrene or styrene/isoprene/styrene block copolymer), a copolyester (such as a mixture of polymethylene glycol represented by a formula HO(CH₂)NOH (wherein N being an integer of 2-10) and a copolyester prepared from (1) hexahydroterephthalic acid, sebacic acid and terephthalic acid, (2) terephthalic acid, isophthalic acid and sebacic acid, (3) terephthalic acid and sebacic acid, (4) a reaction product of terephthalic acid and isophthalic acid, or (5) from the aforementioned glycol and (i) terephthalic acid, isophthalic acid and sebacic acid or (ii) terephthalic acid, isophthalic acid, sebacic acid and adipic acid), poly-N-vinylcarbazole and a copolymer thereof, a carbazole-containing polymer disclosed by H. Kamogawa et al., Journal of Polymer Science, Polymer Chemistry Edition, vol. 18, p. 9-18(1979), and a polycarbonate formed from bisphenol and a carbonate ester.

Also a fluorine-containing polymer is preferable as a low refractive index binder. A preferred example is a polymer soluble in an organic solvent and constituted of a fluoroolefin as an essential component and a copolymerizing component of one or more unsaturated monomers selected from an alkyl vinyl ether, an alicyclic vinyl ether, hydroxy vinyl ether, an olefin, a haloolefin, an unsaturated carboxylic acid or an ester thereof, and a carboxylic acid vinyl ester. It preferably has a weight-averaged molecular weight of 5,000 to 200,000, and a fluorine atom content of 5-70 weight % (mass %).

In the fluorine-containing polymer, the fluoroolefin can be tetrafluoroethylene, chlorotrifluoroethylene, vinyl fluoride, or vinylidene fluoride. Also as another copolymerizing component, the alkyl vinyl ether can be ethyl vinyl ether, isobutyl vinyl ether, or n-butyl vinyl ether; the alicyclic vinyl ether can be cyclohexyl vinyl ether or a derivative thereof, the hydroxyvinyl ether can be hydroxybutyl vinyl ether; the olefin or haloolefin can be ethylene, propylene, isobutylene, vinyl chloride or vinylidene chloride; the carboxylate vinyl ester can be vinyl acetate or vinyl n-butyrate; the unsaturated carboxylic acid or ester thereof can be an unsaturated carboxylic acid such as (meth)acrylic acid or crotonic acid, a C1-C18 alkyl ester of (meth)acrylic acid such as methyl(meth)acrylate, ethyl(meth)acrylate, propyl(meth)acrylate, isopropyl(meth)acrylate, butyl(meth)acrylate, hexyl(meth)acrylate, octyl(meth)acrylate, or lauryl(meth)acrylate, a C2-C8 hydroxyalkyl ester of (meth)acrylic acid such as hydroxyethyl(meth)acrylate, or hydroxypropyl(meth)acrylate, also N,N-dimethylaminoethyl(meth)acrylate, or N,N-diethylaminoethyl(meth)acrylate. Such radical polymerizable monomer may be employed singly or in a combination of two or more kinds, or may be partially replaced, if necessary by another radical polymerizable monomer for example a vinyl compound such as styrene, ac-methylstyrene, vinyltoluene or (meth)acrylonitrile. Also as another monomer derivative, there may also be employed an fluoroolefin containing a carboxylic acid group or a vinyl ether containing a glycidyl group.

A specific example of the fluorine-containing polymer is a Lumiflon series polymer having hydroxyl groups and soluble in organic solvents (for example Lumiflon LF200, weight-averaged molecular weight: ca. 50,000, manufactured by Asahi Glass Co.). Fluorine-containing polymers, soluble in organic solvents, are also commercially available from Daikin Ltd., Central Glass Co., Penwalt Inc. and the like, and such polymer are also usable.

In case the aforementioned photoreactive compound is a polymer compound, it preferably serves also as the binder, and, in such case, the photoreactive compound particularly preferably is a polymer compound in which a photoreactive site is pendant.

In such case, the binder is preferably employed for the alignment control of the low-molecular liquid crystal.

The hologram recording material of the invention may further include, if necessary, additives such as an electron donating compound, an electron accepting compound, a polymerizable monomer, a polymerizable oligomer, a crosslinking agent, a thermal stabilizer, a plasticizer, and a solvent.

In case of employing a sensitizing dye in the hologram recording material of the invention, there can be advantageously employed an electron donating compound having a power of reducing the radical cation of the sensitizing dye or an electron accepting compound having a power of oxidizing the radical anion of the sensitizing dye.

Preferred examples of the electron donating compound include an alkylamine (such as triethylamine, tributylamine, trioctylamine, N,N-dimethyldodecylamine, triethanolamine or triethoxyethylamine), an aniline (such as N,N-dioctylaniline, N,N-dimethylaniline, 4-methoxy-N,N-dibutylaniline, or 2-methoxy-N,N-dibutylaniline), a phenylenediamine (such as N,N,N′,N′-tetramethyl-1,4-phenylenediamine, N,N,N′,N′-tetramethyl-1,2-phenylenediamine, N,N,N′,N′-tetraethyl-1,3-phenylenediamine, or N,N′-dibutylphenylenediamine), a triophenylamine (such as triphenylamine, tri(4-methoxyphenyl)amine, tri(4-dimethylaminophenyl)amine or TPD), a carbazole (such as N-vinylcarbazole, or N-ethylcarbazole), a phenothiazine (such as N-methylphenothiazine, or N-phenylphenothiazine), a phenoxazine (such as N-methylphenoxazine, or N-phenylphenoxazine), a phenazine (such as N,N′-dimethylphenazine or N,N′-diphenylphenazine), a hydroquinone (such as hydroquinone, 2,5-dimethylhydroquinone, 2,5-dichlorohydroquinone, 2,3,4,5-tetrachlorohydroquinone, 2,6-dichloro-3,5-dicyanohydroquinone, 2,3-dichloro-5,6-dicyanohydroquinone, 1,4-dihydroxynaphthalene or 9,10-dihydroxyanthracene), a cathecol (such as cathecol or 1,2,4-trihydroxybenzene), an alkoxybenzene (such as 1,2-dimethoxybenzene, 1,2-dibutoxybenzene, 1,2,4-tributoxybenzene or 1,4-dihexyloxybenzene), an aminophenol (such as 4-(N,N-diethylamino)phenol or N-octylaminophenol), an imidazole (such as imidazole, N-methylimidazole, N-octylimidazole or N-butyl-2-methylimidazole), a pyridine (such as pyridine, picoline, lutidine, 4-t-butylpyridine, 4-octyloxypyridine, 4-(N,N-dimethylamino)pyridine, 4-(N,N-dibutylamino)pyridine or 2-(N-octylamino)pyridine), a metallocene (such as ferrocene, titanocene or ruthenocene), a metal complex (such as Ru-bisbipyridine complex, Cu-phenanthroline complex, Co-trisbipyridine complex, Fe-EDTA complex, or complexes of Ru, Fe, Re, Pt, Cu, Co, Ni, Pd, W, Mo, Cr, Mn, Ir and Ag), and semiconductor fine particles (such as Si, CdSe, GaP, PbS or ZnS). The electron donating compound is more preferably a phenothiazine, and most preferably N-methylphenothiazine.

On the other hand, preferred examples of the electron accepting compound include an aromatic compound in which an electron attracting group is introduced (such as 1,4-dinitrobenzene, 1,4-dicyanobenzene, 4,5-dichloro-1,2-dicyanobenzene, 4-nitro-1,2-dicyanobenzene, 4-octanesulfonyl-1,2-dicyanobenzene, or 1,10-dicyanoanthracene), a heterocyclic compound or a heterocyclic compound in which an electron attracting group is introduced (such as pyrimidine, pyrazine, triazine, dichloropyrazine, 3-cyanopyrazole, 4,5-dicyano-1-methyl-2-octanoylaminoimidazole, 4,5-dicyanoimidazole, 2,4-dimethyl-1,3,4-thiadiazole, 5-chloro-3-phenyl-1,2,4-thiadiazole, 1,3,4-oxadiazole, 2-chlorobenzothiazole, or N-butyl-1,2,4-triazole), an N-alkylpyridinium salt (such as N-butylpyridinium iodide, N-butylpoyridinium bis(trifluoromethanesulfonyl)imide, N-butyl-3-ethoxycarbonyl-pyridinium butanesulfonate, N-octyl-3-carbamoylpyridinium bis(triflluoromethanesulfonyl)imide, N,N-dimethylbiologen di(hexafluorophosphate), or N,N-diphenylbiologen bis(bis(trifluoromethanesulfonyl)imide), a benzoquinone (such as benzoquinone, 2,5-dimethylbenzoquinone, 2,5-dichlorobenzoquinone, 2,3,4,5-tetrachlorobenzoquinone, 2,5-dichlorobenzoquinone, 2,3,4,5-tetrachlorobenzoquinone, 2,6-dichloro3,5-dicyanobenzoquinone, 2,3-dichloro-5,6-dicyanobenzoquinone, naphthoquinone or anthraquinone), an imide (such as N,N′-dioctylpyromellitimide or 4-nitro-N-octylphthalimide), a metal complex (such as Ru-trisbipyridine complex, Ru-bisbipyridine complex, Co-trisbipyridine complex, Cr-trisbipyridine complex, PtCl₆ complex, or complexes of Ru, Fe, Re, Pt, Cu, Co, Ni, Pd, W, Mo, Cr, Mn, Ir or Ag), and semiconductor fine particles (such as TiO₂, Nb₂O₅, ZnO, SnO₂, Fe₂O₃ or WO₃).

The electron donating compound preferably has an oxidation potential baser (more minus) than the oxidation potential of the sensitizing dye or the reduction potential of the excited state of the sensitizing dye, and the electron accepting compound preferably has a reduction potential more precious (more plus) than the reduction potential of the sensitizing dye or the oxidation potential of the excited state of the sensitizing dye.

A preferred example of the polymerizable monomer, the polymerizable oligomer and the crosslinking agent, in the use in the hologram recording material of the invention, is described for example in Japanese Patent Application No. 2003-82732.

In the hologram recording material of the invention, a chain transfer agent may be advantageously employed in certain cases. Examples of a preferred chain transfer agent include a thiol, such as 2-mercaptobenzoxazol, 2-mercaptobenzthiazole, 2-mercaptobenzimidazole, 4-methyl-4H-1,2,4-triazole-3-thiol, 4,4-thiobisbenzenethiol, p-bromobenzenethiol, thiocyanuric acid, 1,4-bis(mercaptomethyl)benzene, p-toluenethio, thiols described in U.S. Pat. No. 4,414,312 and JP-A-64-13144, disulfides described in JP-A-2-291561, thions described in U.S. Pat. No. 3,558,322 and JP-A-64-17048, o-acylthiohydroxamates and N-alkoxypyridinethions described in JP-A-2-291560.

In particular, the chain transfer agent is advantageously employed in case the polymerization initiator is 2,4,5-triphenylimidazole dimmer.

The chain transfer agent is preferably employed in an amount of 1.0-30 weight % with respect to the entire composition.

In the hologram recording material of the invention, a thermal stabilizer may be added for improving storability in storage.

A useful thermal stabilizer can be hydroquinone, phenidone, p-methoxyphenol, an alkyl- or aryl-substituted hydroquinone or quinone, cathecol, t-butylcathecol, pyrogallol, 2-naphthol, 2,6-di-t-butyl-p-cresol, phenothiazine, and chloranile. Dinitrodimers described by Pazos in U.S. Pat. No. 4,168,982 can also be employed advantageously.

A plasticizer is employed for varying various mechanical properties such as an adhesion property, a flexibility, a hardness and the like of the hologram recording material. The plasticizer can be, for example, triethylene glycol dicaprylate, triethylene glycol bis(2-ethylhexanoate), tetraethylene glycol diheptanoate, diethyl sebacate, dibutyl suberate, tris(2-ethylhexyl) phosphate, tricresyl phosphate, dibutyl phthalate, an alcohol or a phenol.

In the hologram recording material and the composition of the invention, each component is preferably within a following range of percentage, with respect to the entire weight (mass) of the composition:

binder: preferably 0-95 weight %, more preferably 0-70 weight %;

liquid crystalline compound: preferably 10-99 weight %, more preferably 30-99 weight %;

photoreactive compound: preferably 0.1-30 weight %, more preferably 1-10 weight %;

polymerization initiator: preferably 0.1-20 weight %, more preferably 1-10 weight %;

sensitizing dye: preferably 0-10 weight %, more preferably 0.1-5 weight %.

The hologram recording material of the invention can be prepared by an ordinary method.

For example, the hologram recording material of the invention can be prepared by a film forming method such as dissolving the binder and the components in a solvent and coating such solution with a spin coater or a bar coater.

A preferred solvent in such operation can be, for example, a ketone solvent such as methyl ethyl ketone, methyl isobutyl ketone, acetone, or cyclohexanone; an ester solvent such as ethyl acetate, butyl acetate, ethylene glycol diacetate, ethyl lactate, or cellosolve acetate; a hydrocarbon solvent such as cyclohexane, toluene or xylene; an ether solvent such as tetrahydrofuran, dioxane or diethyl ether; a cellosolve solvent such as methyl cellosolve, ethyl cellosolve, butyl cellosolve, or dimethyl cellosolve; an alcohol solvent such as methanol, ethanol, n-propanol, 2-propanol, n-butanol, or diacetone alcohol; a fluorinated solvent such as 2,2,3,3-tetrafluoropropanol; a halogenated hydrocarbon solvent such as dichloromethane, chloroform or 1,2-dichloroethane; an amide solvent such as N,N-dimethylformamide; or a nitrile solvent such as acetonitrile or propionitrile.

The hologram recording material of the invention can be directly coated on a substrate by a spin coater, a roll coater or a bar coater, or cast as a film and laminated on a substrate by an ordinary method, thereby forming a hologram recording material.

The “substrate” means an arbitrary natural or synthetic support member, preferably such member that can assume a form of a flexible or rigid film, sheet or plate.

The substrate is preferably polyethylene terephthalate, polyethylene terephthalate undercoated with a resinous material, polyethylene terephthalate subjected to a flame treatment or an electrostatic discharge treatment, cellulose acetate, polycarbonate, polymethyl methacrylate, polyester, polyvinyl alcohol or glass.

The employed solvent may be eliminated by evaporation in a drying operation. The elimination by evaporation may be performed by heating or under a reduced pressure.

The hologram recording material of the invention may also be formed into a film by melting a binder, containing the components, at a temperature equal to or higher than a glass transition temperature or a melting temperature of the binder and performing a melt extrusion or an injection molding. In such case, the film strength may be increased by employing a reactive crosslinking binder and curing the film by a crosslinking after the extrusion or molding. In such case, for the crosslinking reaction, there can be utilized a radical polymerization reaction, a cationic polymerization reaction, a condensation polymerization reaction, or an addition polymerization reaction. Also there can be utilized methods described in JP-A-2000-250382 and JP-A-2000-172154.

Also there can be advantageously employed a method of dissolving the components in a monomer solution for forming a binder, and thermally or optically polymerizing the monomer to obtain a polymer serving as the binder. Also for such polymerization, there can be utilized a radical polymerization reaction, a cationic polymerization reaction, a condensation polymerization reaction, or an addition polymerization reaction.

In the invention, an alignment film may be employed on the substrate, in order to align the liquid crystalline compound. The alignment film may be obtain by a rubbing process or a photoaligning process. An alignment film formed by a rubbing may be formed by polyvinyl alcohol or polyimide. Also an alignment film formed by a photoalignment is described for example in “Liquid Crystal”, vol. 3, p. 3(1999). Also so-called “command surface” described in “Oyo Buturi” vol. 62, p. 998(1993) and “Kobunshi Kako” vol. 49, p. 50(2000).

On the hologram recording material, a protective layer may be provided for intercepting oxygen. The protective layer can be formed by adhering a plastic film or plate for example of a polyolefin such as polypropylene or polyethylene, polyvinyl chloride, polyvinylidene chloride, polyvinyl alcohol, polyethylene terephthalate or cellophane by an electrostatic adhesion or by a lamination by an extruder, or by coating a solution of such polymer. Also a glass plate may be adhered. Also an adhesive material or a liquid material may be provided, for the purpose of improving the air tight property, between the protective layer and the photosensitive film and/or between the substrate and the photosensitive film.

In case of employing the hologram recording material of the invention for a holographic memory, the hologram recording material is preferably free from a shrinkage between before and after the hologram recording, in order to improve an S/N ratio at the signal reproduction.

For this purpose, in the hologram recording material of the invention, there can be advantageously employed an inflating agent described in JP-A-2000-86914 or a binder resistant to shrinkage described in JP-A-2000-250382, JP-A-2000-172154 and JP-A-11-344917.

It is also preferable to regulate the spacing of the interference fringes by employing a diffusing element described for example in JP-A-3-46687, JP-A-5-204288 and JP-T-9-506441.

In case of employing the hologram recording material of the invention for an optical recording medium, the hologram recording material is preferably stored, in a storage state, in a light-shielding cartridge.

It is also preferable that the hologram recording material is provided on a front surface and/or a rear surface thereof with a light cut-off filter capable of intercepting a part of the ultraviolet, visible and infrared wavelength regions, excluding the wavelengths of the recording light and the reproducing light.

In case of employing the hologram recording material of the invention for an optical recording medium, the optical recording medium may have a disk shape, a card shape, a tape shape or any other shape.

The hologram recording material of the invention is applicable, in addition to the optical recording medium, also to a three-dimensional display hologram, a holographic optical element (HOE such as a head-up display (HUD) for an automobile, a pickup lens for an optical disk, a head-mount display, a color filter for a liquid crystal display, a reflecting plate for a reflective liquid crystal display, a lens, a diffraction grating, an interference filter, a coupler for an optical fiber, a photodeflector for a facsimile, and a window pane material for a building), a front cover of books and magazines, a display such as POP, a gift item, or also a credit card, a banknote, a package etc. for the purpose of antiforging.

### EXAMPLES

In the following there will be shown examples of the present invention, but the invention is not limited to such examples.

### Example 1

Compositions 101-106 for the hologram recording material were prepared, under a red light, by dissolving a sensitizing dye, an electron donating compound, a pohotoreactive compound, a polymerization initiator (+ chain transfer agent), a liquid crystalline compound having a polymerizable group, and a binder in methylene chloride of 2-4 times amount (in combination with acetonitrile, acetone and methanol if necessary) as shown in Table 1. In Table 1, percentage is represented by weight %.

TABLE 1
I-1

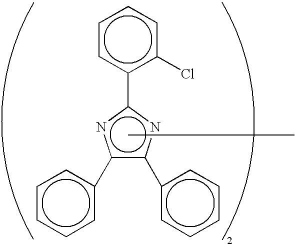

I-2

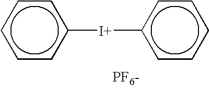

MBO

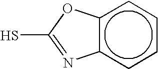

PMMA-EA

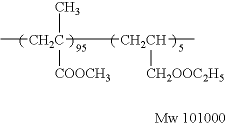

PMMA

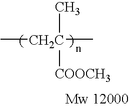

ED-1

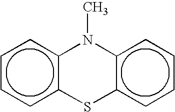

| sensitizing dye | | | | | | | liquid crystalline | | |
|---|---|---|---|---|---|---|---|---|---|
| | electron | | | | polymerization | | compound with | | |
| | donating | | photo-reactive | | initiator chain | | polymerizable | | |
| sample | agent | | compound | | transfer agent | | group | | binder |
| 101 | D-95 | 4% | R-4 | 5% | I-2 | 5% | LC-19 | 86% | — |
| 102 | D-118 | 0.8% | R-2 | 5% | I-1 | 1.8% | LC-22 | 45% | PMMA-EA |
| | ED-1 | 5% | | | MBO | 1.2% | | | 41.2% |
| 103 | D-118 | 0.8% | R-48 | 30% | I-2 | 5% | LC-19 | 59.2% | — |
| | ED-1 | 5% | | | | | | | |

| | | | | | | | | |
|---|---|---|---|---|---|---|---|---|
| 104 | — | R-6 | 5% | I-1 | 1.8% | LC-22 | 92% | — |
| | | | | MBO | 1.2% | | | |
| 105 | — | R-7 | 5% | I-2 | 5% | LC-19 | 40% | PMMA |
| | | | | | | | | 50% |
| 106 | — | R-48 | 30% | I-2 | 5% | LC-19 | 65% | — |

Each of the compositions 101-106 for the hologram recording material was coated (coated plural times if necessary) on a glass substrate with a blade so as to obtain a thickness of about 80 μm thereby forming a photosensitive layer, and the solvent was distilled off by drying at 40° C. for 3 minutes. Then the photosensitive layer was covered with a TAC film to obtain hologram recording materials 101-106.

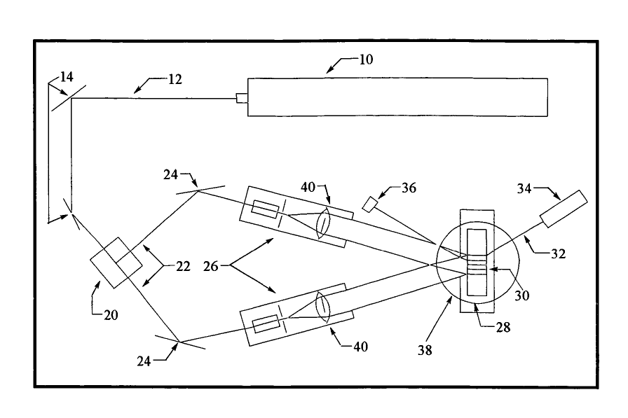

The hologram recording material was recorded upon an exposure on a two-beam optical system for transmission hologram recording as shown in FIG. 1, utilizing a second harmonic wave of a YAG laser (532 Nm, output 2 W) as a light source. An angle between the object light and the reference light was 30°. The beam had a diameter of 0.6 cm and an intensity of 8 mW/cm², and the exposure was made by changing the exposure time within a range of 0.1 to 400 seconds (irradiation energy within a range of 0.8-3200 mJ/cm²). During the holographic exposure, a He—Ne laser beam of 632 Nm was passed at Bragg's angle through the center of the exposure area, and a ratio of the diffracted light to the incident light (absolute diffraction efficiency) was measured on real-time basis.

As a result, in any of the samples 101-106 of the hologram recording material of the invention, a diffraction of He—Ne laser was observed with a high efficiency, thereby confirming the hologram recording in this method. It was also confirmed that, by a flush irradiation with a visible to ultraviolet light of a xenon lamp at the room temperature, the record could be preserved and fixed by a polymerization over the entire surface. It was also confirmed that the record could be preserved satisfactorily, since a recording operation thereafter cannot be achieved and the record did not disappear by a heating or a flush exposure of a recorded hologram.

The hologram recording material of the invention, relying on a method of achieving a hologram recording by a refractive index modulation resulting from a change in alignment of a liquid crystalline compound in its position, without involving a material transfer as in the prior photopolymer system, and of fixing such alignment change by a polymerization thereby disabling rewriting, is totally different in the recording method from the known hologram recording materials and is particularly suitable for the holographic memory of add-on type.

Also the hologram recording material of the invention shows an increase of ΔN (amount of refractive index modulation in the interference fringes, calculated by Kugelnik's equation from the diffraction efficiency and the film thickness) substantially linearly with an exposure amount (mJ/cm²), and is therefore advantageous for multiplex recording.

The hologram recording material of the invention was subjected to hologram recordings of 10 times (multiplex hologram recording) on a same position, with an exposure amount of 1/10 of the exposure amount providing the aforementioned maximum diffraction efficiency and by changing the angle of the reference light by 2° each time, and after a fixation by a flush exposure, it was confirmed that each object light could be reproduced by changing the angle of the reproducing light by 2° each time. It was thus confirmed that hologram recording material of the invention was capable of multiplex recording with a same exposure amount and had a property suitable for multiple recording. Therefore, the hologram recording material of the invention is capable of a high-density (high-capacity) recording by such a multiplex recording of a large recording number.

In contrast, the hologram recording material of known photopolymer system, as described for example in JP-A-6-43634, was identified to show a slower movement of the monomer necessary for recording because of a progressed polymerization of the photopolymer in the latter stage of the multiplex recording, thereby requiring a larger irradiating light amount for performing a same recording, in comparison with the initial stage and constituting a difficulty in increasing the level of multiplicity or the recording density.

Similar results could be obtained in the samples 101-103, by changing the sensitizing dye to D-1, D-22, D-31, D-49, D-53, D-55, D-74, D-87, D-91, D-97, D-107, D-115, D-116, D-117 or D-119. Also similar results could be obtained in the samples 101, 102, 104 and 105 by changing the photoreactive compound to R-1, R-3, R-9, R-10, R-13, R-15, R-18, R-19, R-23, R-24, R-32, R-34, R-35, R-38 or R-40.

Also similar results could be obtained in the samples 103 and 106 by changing the photoreactive compound to R-41 or R-49.

Also similar results could be obtained in the samples 102 and 104 by changing the liquid crystalline compound having the radical polymerizable group to LC-2, LC-4, LC-10, LC-14, LC-25, LC-28 or LC-33.

Also similar results could be obtained in the samples 101, 103, 105 and 106 by changing the liquid crystalline compound having the radical polymerizable group to LC-3, LC-5, LC-7, LC-11, LC-15, LC-17, LC-20, LC-26 or LC-35.

Also similar results could be obtained in the samples 102 and 104 by changing the radical polymerization initiator to Irgacure 907, Irgacure 184 or Irgacure 651 which is a ketone polymerization initiator.

Also similar results could be obtained in the samples 101, 103, 105 and 106 by changing the cationic polymerization initiator (acid generating agent) to tris(4-methylphenyl)sulfonium tetra(pentafluorophenyl)borate, triphenylsulfonium perfluoropentanoate, bis(1-(4-diphenylsulfonium)phenyl sulfide ditriflate, dimethylphenacylsulfonium perfluorobutanesulfonate, diphenyliodonium triflate, or 4-octyloxyphenylphenyliodonium hexafluoroantimonate.

Also similar results could be obtained in the samples 102 and 105 by changing the binder to polymethyl methacrylate (Now: 996,000, 350,000), methyl methacrylate-butyl acrylate copolymer (Mw: 75,000), polyvinyl acetal (mW: 83,000), polycarbonate or cellulose acetate butyrate.

The invention is expected for use in an advanced three-dimensional optical recording medium adapted for the highly advanced information society.

While the invention has been described in detail and with reference to specific embodiments thereof, it will be apparent to one skilled in the art that various changes and modifications can be made therein without departing from the spirit and scope thereof

The entire disclosure of each and every foreign patent application from which the benefit of foreign priority has been claimed in the present application is incorporated herein by reference, as if fully set forth herein.

What is claimed is:

1. A hologram recording method comprising:
causing a change in an alignment of a compound having a specific birefringence upon holographic exposure; and
fixing the alignment of the compound by a chemical reaction to form an unrewritable modulation in refractive index.

2. The hologram recording method according to claim 1, wherein the compound having the specific birefringence has a polymerizable group, and the fixing is performed by polymerizing the compound.

3. The hologram recording method according to claim 1, wherein the compound having the specific birefringence is a liquid crystalline compound.

4. A hologram recording material comprising: a low-molecular liquid crystalline compound having a polymerizable group; a photoreactive compound; and a polymerization initiator,
wherein the hologram recording material is an unrewritable recording material.

5. The hologram recording material according to claim 4, further comprising a sensitizing dye.

6. The hologram recording material according to claim 5, wherein the sensitizing dye transfer an electron or energy from an excited state thereof, which is generated by absorption of light at holographic exposure, to the photoreactive compound so as to cause a reaction of the photoreactive compound.

7. The hologram recording material according to claim 4, wherein the photoreactive compound is a photoisomerizable compound.

8. The hologram recording material according to claim 4, wherein the photoreactive compound is at least one of an azobenzene compound, a stilbene compound, a spiropyrane compound, a spirooxazine compound, a diarylethene compound, a fulgide compound, a fulgimide compound, a cinnamic acid compound, a coumarin compound, and a calcon compound.

9. The hologram recording material according to claim 4, wherein the photoreactive compound is a polymer compound having a pendant photoreactive site.

10. The hologram recording material according to claim 4, wherein the low-molecular liquid crystalline compound is at least one of a nematic liquid crystalline compound, a smectic liquid crystalline compound, a discotic nematic liquid crystalline compound, a discotic liquid crystalline compound, and a cholesteric liquid crystalline compound.

11. The hologram recording method according to claim 3, wherein the hologram recording is performed at a temperature at which the liquid crystalline compound is in a liquid crystal state.

12. A hologram recording method, comprising recording a hologram in a hologram recording material according to claim 4 at a temperature at which the liquid crystalline compound is in a liquid crystal state.

13. The hologram recording method according to claim 1, which is a method for recording a volume hologram.

14. The hologram recording method according to claim 13, wherein a multiplex hologram recording is performed by effecting the holographic exposure 10 times or more.

15. The hologram recording method according to claim 14, wherein the multiplex hologram recording is performed under a common exposure amount in each holographic exposure.

16. A three-dimensional display hologram recorded in a hologram recording material according to claim 4.

17. A holographic optical element, comprising a hologram recording material according to claim 4.
